(19) United States
(12) Patent Application Publication
(10) Pub. No.: US 2021/0162338 A1
(43) Pub. Date: Jun. 3, 2021

(54) WATER CAPTURE

(71) Applicant: UNIVERSITY OF LIMERICK, Limerick (IL)

(72) Inventors: Michael John ZAWOROTKO, Limerick (IE); Victoria Gascón PÉREZ, Limerick (IE); Andrey Alexandrovich BEZRUKOV, Limerick (IE); Daniel John O'HEARN, Limerick (IE); Shiqiang WANG, Limerick (IE)

(21) Appl. No.: 17/263,385

(22) PCT Filed: Jul. 26, 2019
(86) PCT No.: PCT/EP2019/070275

§ 371 Date: Jan. 26, 2021

(30) Foreign Application Priority Data
Jul. 26, 2018 (EP) 18185922.4

(51) Int. Cl. B01D 53/26; B01D 53/02; B01J 20/22; B01D 53/28

(52) U.S. Cl. CPC B01D 53/261; B01D 53/02; B01J 20/226; B01D 2253/204; B01D 2257/80; B01D 2253/308; B01D 53/28

(57) ABSTRACT

A method of capturing water from a gaseous composition comprising water vapour (suitably air), the method comprising: (a) providing a metal-organic material; and (b) contacting themetal-organic material with water and/or water vapour; wherein upon contact with water and/or water vapour the material switches from a first state to a second state wherein the second state is able to retain a higher amount of water than the first state.

Atmospheric water vapour is an underexploited natural water resource. Water captured from air has many potential uses. For example, it could be used to provide access to clean drinking water, be used in agriculture in arid environments or be used to provide high-purity water for medical and industrial applications.

The control of humidity in heating, ventilation and air conditioning (HVAC) systems also involves water capture. HVAC systems use substantial amounts of energy and thus even a small reduction in energy consumption can be highly beneficial.

Research in this area has focused on molecular sieve materials such as zeolites and mesoporous silica. These porous materials contain many cavities for the adsorption of small molecules, and are also used in related applications for example carbon dioxide capture and gas separation. However, water capture and delivery using these materials is too energy intensive to be economically viable, as desorption requires significant heating. Therefore, there is a need for new classes of sorbent materials that are able to capture water vapour over a range of humidities and offer low energy footprints for recycling.

Metal-organic materials are a class of materials in which cages or networks are formed by the linking of metal clusters or metal cations by organic linker ligands. Recently, a class of metal-organic materials known as metal-organic frameworks (MOFs) have received attention for use in water capture devices. However, like zeolites and mesoporous silica, many of these materials possess a rigid three-dimensional framework, which is often highly strained, affording poor recyclability, with structures collapsing when subjected to reversibility tests due to low thermal and/or hydrolytic stabilities. Consequently many such materials have a low working capacity, caused by poor water uptake and/or unsuitable adsorption profiles.

However the present inventors have surprisingly found some metal-organic materials which have excellent water adsorption properties.

It is an aim of the present invention to provide improved means for capturing water vapour from air.

According to a first aspect of the present invention there is provided a method of capturing water from a gaseous composition comprising water vapour, the method comprising:
(a) providing a metal-organic material; and
(b) contacting the metal-organic material with water and/or water vapour;
   wherein upon contact with water and/or water vapour the material switches from a first state to a second state wherein the second state is able to retain a higher amount of water than the first state.

According to a second aspect of the present invention there is provided the use of a metal-organic material to capture water from a gaseous composition comprising water vapour.

According to a third aspect of the present invention there is provided a metal-organic material wherein said material can exist in a first state and a second state; wherein switching from said first state to said second state occurs upon contact of the material with water and/or water vapour; and wherein said second state is able to retain a higher amount of water than said first state.

According to a fourth aspect of the present invention there is provided a device for capturing water from a gaseous composition comprising water vapour, the device comprising a metal-organic material and a support. Suitably the metal-organic material can exist in a first state and a second state; wherein switching from said first state to said second state occurs upon contact of the material with water and/or water vapour; and wherein said second state is able to retain a higher amount of water than said first state.

Preferred features of the first, second, third and fourth aspects of the invention will now be described.

The present invention relates to the use of a metal-organic material to capture water from a gaseous composition comprising water vapour. Preferably the gaseous composition comprising water vapour is air.

Thus the first aspect of the present invention suitably involves a method of capturing water from air, the method comprising:
(a) providing a metal-organic material; and
(b) contacting the metal-organic material with water and/or water vapour;
   wherein upon contact with water and/or water vapour the material switches from a first state to a second state wherein the second state is able to retain a higher amount of water than the first state.

The second aspect of the present invention suitably involves the use of a metal-organic material to capture water from air.

The fourth aspect of the present invention suitably involves a device for capturing water from air comprising a metal-organic material and a support.

The present invention relates to metal-organic materials. Metal-organic materials (or MOMs) is a term used to describe materials comprising metal moieties and organic ligands including a diverse group of discrete (e.g. metal-organic polyhedra, spheres or nanoballs, metal-organic polygons) or polymeric structures (e.g. porous coordination polymers (PCPs), metal-organic frameworks (MOFs) or hybrid inorganic-organic materials). Thus metal-organic materials encompass discrete as well as extended structures with periodicity in one, two, or three dimensions.

The present invention relates to metal-organic materials which can exist in a first state and a second state. The second state is able to retain a higher amount of water than the first state. This change in state occurs upon exposure to water and/or water vapour. The first state may be regarded as an empty state in which no water or very low levels of water are retained in the material. The second state may be regarded as a loaded state in which water is retained within the material.

The metal-organic materials of the present invention suitably comprise metal species and ligands. In some embodiments these may be linked in substantially two-dimensions with weaker forces between two-dimensional layers. In some embodiments the metal species and ligands are linked in three dimensions to provide a metal-organic framework material or MOF.

The term metal species as used herein may refer to a metal cation or metal cluster that serves as a node in a metal-organic species.

Some preferred metal species for use herein are d-block metals, for example transition metal species. These are suitably present as transition metal ions. Other metal species that may be useful herein are magnesium, calcium and aluminium.

In especially preferred embodiments the metal species is selected from copper, cobalt, nickel, iron, zinc, cadmium, zirconium, magnesium, calcium and aluminium.

Most preferably the metal species is selected from Cu²⁺, Co²⁺, Ni²⁺, Fe²⁺, Fe³⁺, Zn²⁺, Cd²⁺, Zr⁴⁺, Mg²⁺, Ca²⁺ and Al³⁺.

In some embodiments the metal-organic material may comprise a mixture of two or more metal species. In preferred embodiments all of the metal species in the metal-organic material are the same.

The metal-organic materials defined herein suitably comprise ligands. Unless otherwise specified we mean to refer to linker ligands which provide a link between two or more metal species.

Suitably the ligand is a multidentate ligand.

The metal-organic material may comprise a mixture of two or more different ligands. Preferably all of the ligands in the metal-organic material are the same.

In preferred embodiments the ligand is a bidentate ligand.

In especially preferred embodiments the ligand is an organic bidentate ligand. Suitable organic bidentate ligands may be aliphatic or aromatic in character.

Bidentate ligands suitably include at least two donor atoms. These are atoms that are able to donate an electron pair to form a coordinate bond, suitably a coordinate covalent bond.

In the organic bidentate ligands used in the present invention, the two donor atoms may be selected from halogens, sulphur, oxygen and nitrogen. The two donor atoms may each be the same or different.

Suitably the donor atoms are selected from oxygen and nitrogen.

Preferred ligands for use herein are compounds including one or more nitrogen atoms and/or one or more carboxylic acid (COOH) groups. When incorporated into the metal-organic material carboxylic acid groups typically bind to a metal species as a carboxylate anion.

Preferred ligands for use herein are compounds including one or more aromatic nitrogen atoms and/or one or more carboxylic acid groups.

In some preferred embodiments the metal-organic material comprises an organic bidentate ligand having two donor nitrogen atoms. These may be referred to herein as bidentate nitrogen ligands.

Preferred bidentate nitrogen ligands comprise at least one nitrogen-containing heterocycle. In some embodiments the bidentate nitrogen ligand may be a nitrogen-containing heterocycle comprising two nitrogen atoms each having a lone pair of electrons, for example pyrazine.

The bidentate ligand may comprise multiple aromatic rings including multiple nitrogen containing aromatic heterocycles, which may contain one or more nitrogen atoms and optionally one or more further heteroatoms. For example these may include aromatic moieties based on pyridine, pyrazine, imidazole, pyrimidine, pyrrole, pyrazole, isoxazole and oxazole. Also suitable are compounds based on bicyclic aromatic heterocycles, for example indole, purine, isoindole, pteridine, quinoline, benzotriazole and isoquinoline.

Nitrogen containing aromatic heterocyclic ligands may be incorporated into the metal-organic material in protonated or deprotonated form.

In some embodiments the bidentate nitrogen ligand comprises two nitrogen-containing heterocycles, which may be linked by a bond. One such preferred bidentate ligand is 4,4′-bipyridine (L1):

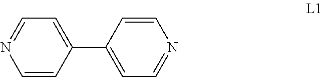 [SMILES: c1cc(-c2ccncc2)ccn1]

Alternatively, the two nitrogen-containing heterocycles may be linked together by a spacer group. Suitably the bidentate nitrogen ligand has the formula (L2N):

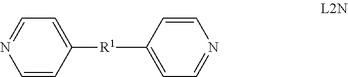

wherein R¹ is an optionally substituted spacer group.

R¹ may be a heteroatom, a group of connected heteroatoms or a group comprising heteroatoms. For example R¹ may be a —N═N— group.

R¹ may be a hydrocarbyl group. The hydrocarbyl group may comprise a cyclic group. The hydrocarbyl group may comprise an aromatic cyclic group. The hydrocarbyl group may comprise a heterocyclic group.

As used herein, the term “hydrocarbyl” is used in its ordinary sense, which is well-known to those skilled in the art. Specifically, it refers to a group having predominantly hydrocarbon character. Examples of hydrocarbyl groups include:

(i) hydrocarbon groups, that is, aliphatic (which may be saturated or unsaturated, linear or branched, e.g., alkyl or alkenyl), alicyclic (e.g., cycloalkyl, cycloalkenyl) substituents, and aromatic-, aliphatic-, and alicyclic-substituted aromatic substituents, as well as cyclic substituents wherein the ring is completed through another portion of the molecule (e.g., two substituents together form a ring);

(ii) substituted hydrocarbon groups, that is, substituents containing non-hydrocarbon groups which, in the context of this invention, do not alter the predominantly hydrocarbon nature of the substituent (e.g., halo (especially chloro and fluoro), hydroxy, alkoxy, keto, acyl, cyano, mercapto, alkylmercapto, amino, alkylamino, nitro, nitroso, and sulphoxy);

(iii) hetero substituents, that is, substituents which, while having a predominantly hydrocarbon character, in the context of this invention, contain other than carbon in a ring or chain otherwise composed of carbon atoms. Heteroatoms include sulphur, oxygen, nitrogen and encompass substituents such as pyridyl, furyl, thienyl and imidazolyl.

Suitable bidentate nitrogen ligands for use herein include compounds L1 to L68:

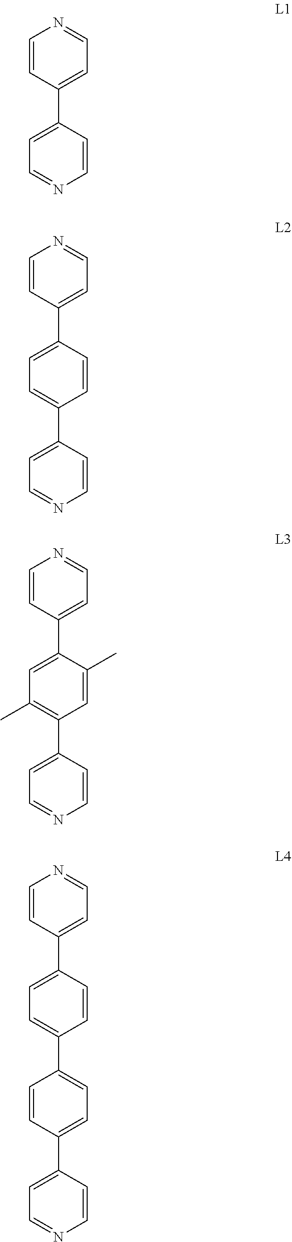

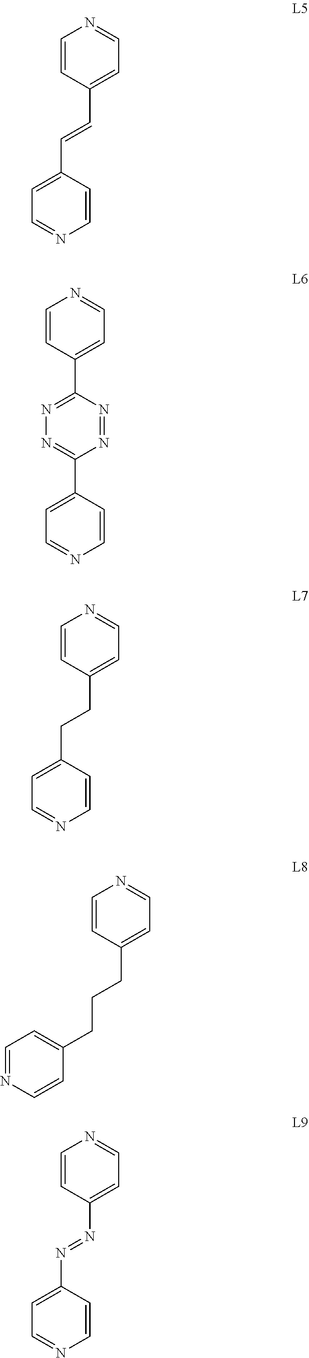 [SMILES: C(=C\c1ccncc1)/c1ccncc1 ; c1cc(-c2nnc(-c3ccncc3)nn2)ccn1 ; c1cc(CCc2ccncc2)ccn1 ; c1cc(CCCc2ccncc2)ccn1 ; c1cc(/N=N/c2ccncc2)ccn1]

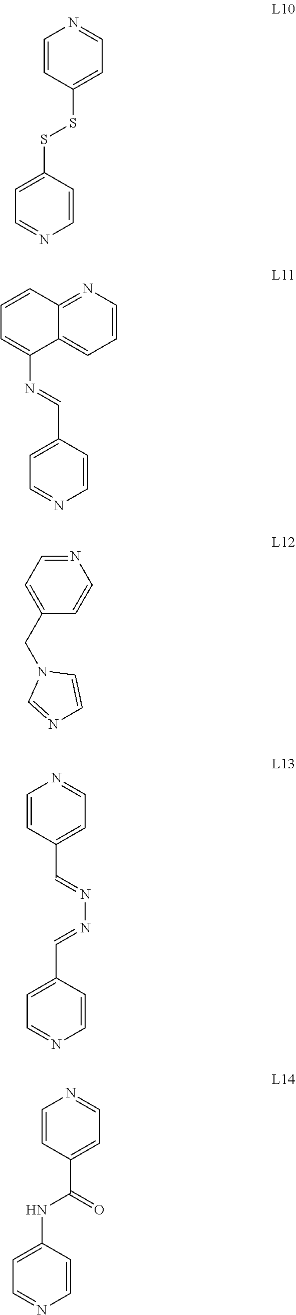 [SMILES: c1cc(SSc2ccncc2)ccn1 ; C(=N\c1cccc2ncccc12)/c1ccncc1 ; c1cc(Cn2ccnc2)ccn1 ; C(=N\N=C\c1ccncc1)/c1ccncc1 ; O=C(Nc1ccncc1)c1ccncc1]

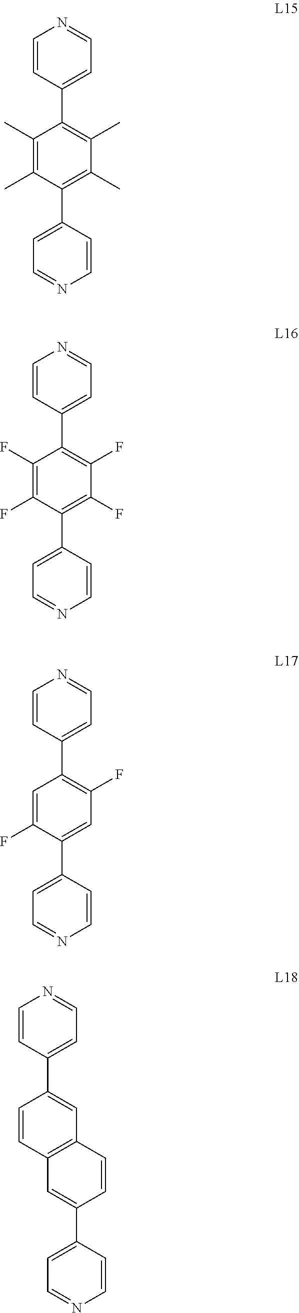

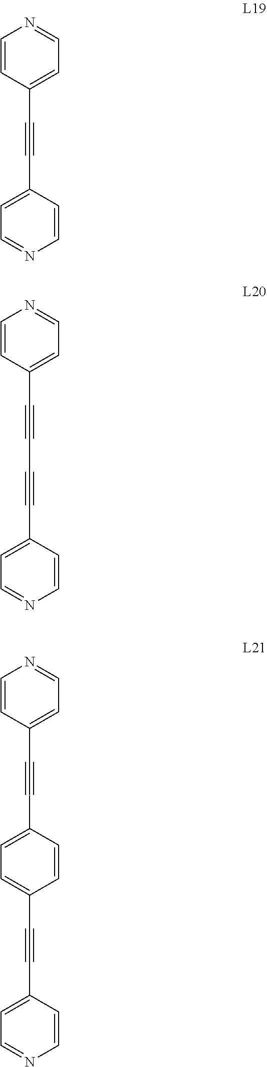 [SMILES: C(#Cc1ccncc1)c1ccncc1 ; C(C#Cc1ccncc1)#Cc1ccncc1 ; C(#Cc1ccc(C#Cc2ccncc2)cc1)c1ccncc1]

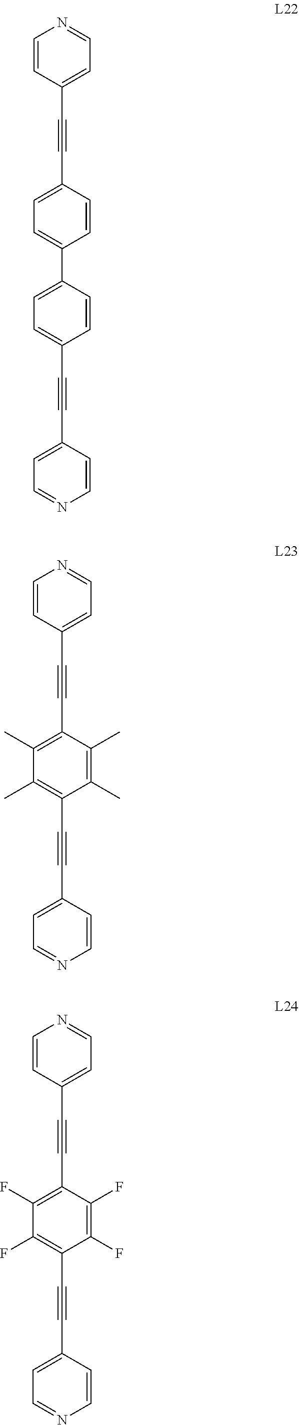

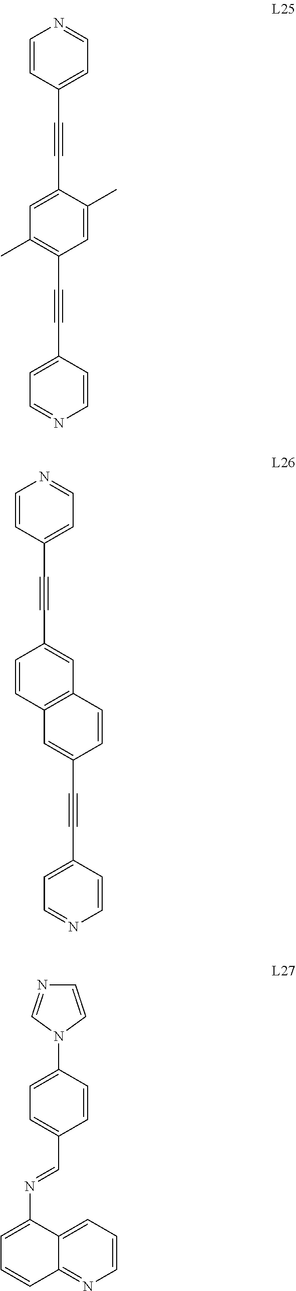

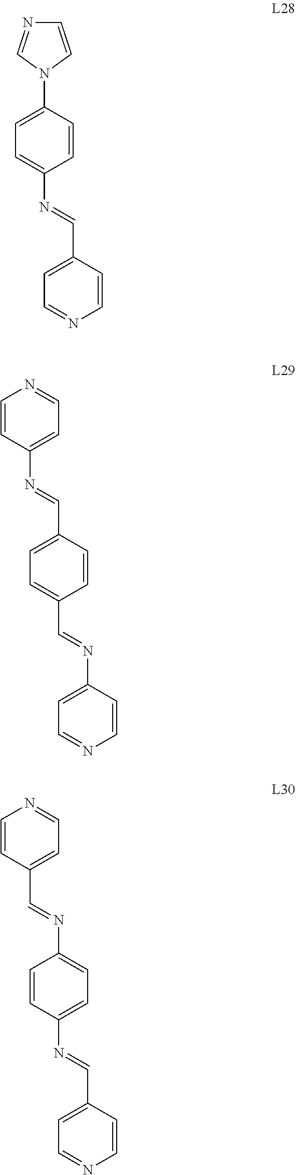 [SMILES: C(=N\c1ccc(-n2ccnc2)cc1)/c1ccncc1 ; C(=N\c1ccncc1)/c1ccc(/C=N/c2ccncc2)cc1 ; C(=N\c1ccc(/N=C/c2ccncc2)cc1)/c1ccncc1]

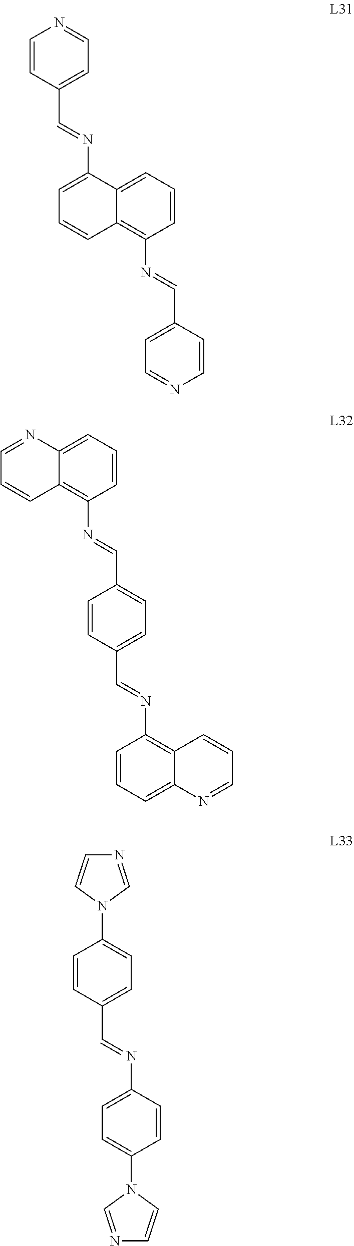 [SMILES: C(=N\c1cccc2c(/N=C/c3ccncc3)cccc12)/c1ccncc1 ; C(=N\c1cccc2ncccc12)/c1ccc(/C=N/c2cccc3ncccc23)cc1 ; C(=N\c1ccc(-n2ccnc2)cc1)/c1ccc(-n2ccnc2)cc1]

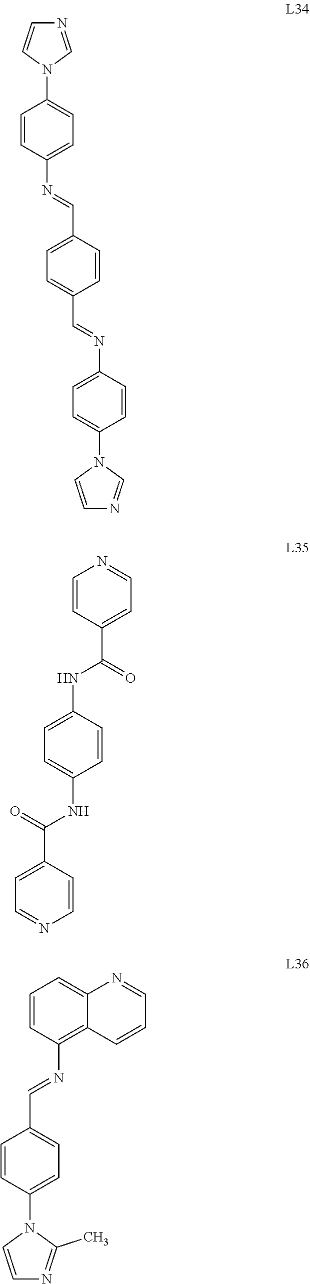 [SMILES: C(=N\c1ccc(-n2ccnc2)cc1)/c1ccc(/C=N/c2ccc(-n3ccnc3)cc2)cc1 ; O=C(Nc1ccc(NC(=O)c2ccncc2)cc1)c1ccncc1 ; Cc1nccn1-c1ccc(/C=N/c2cccc3ncccc23)cc1]

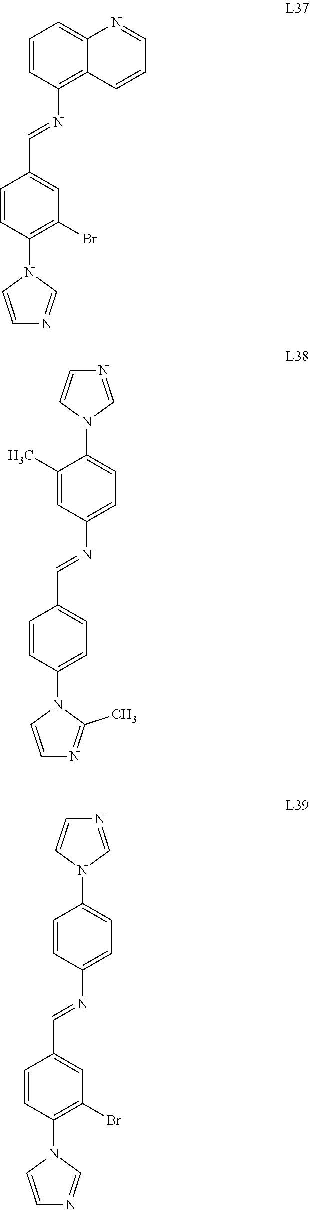 [SMILES: Brc1cc(/C=N/c2cccc3ncccc23)ccc1-n1ccnc1 ; Cc1cc(/N=C/c2ccc(-n3ccnc3C)cc2)ccc1-n1ccnc1 ; Brc1cc(/C=N/c2ccc(-n3ccnc3)cc2)ccc1-n1ccnc1]

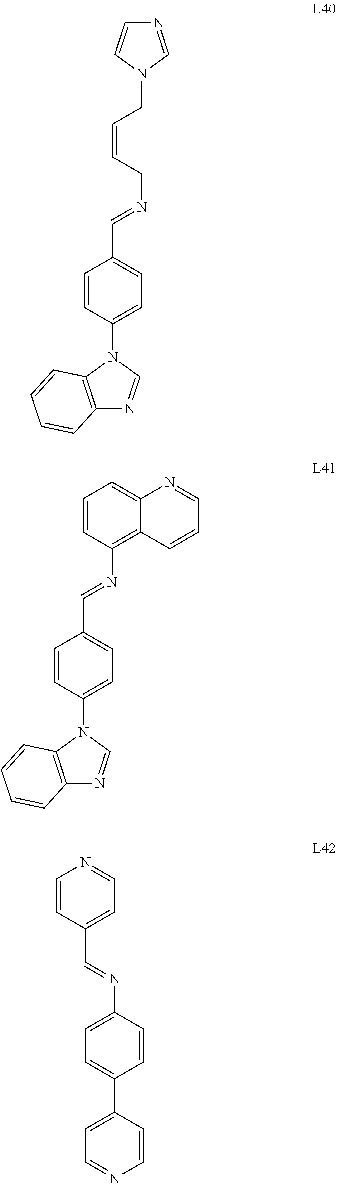 [SMILES: C(=C/Cn1ccnc1)/C/N=C/c1ccc(-n2cnc3ccccc32)cc1 ; C(=N\c1cccc2ncccc12)/c1ccc(-n2cnc3ccccc32)cc1 ; C(=N\c1ccc(-c2ccncc2)cc1)/c1ccncc1]

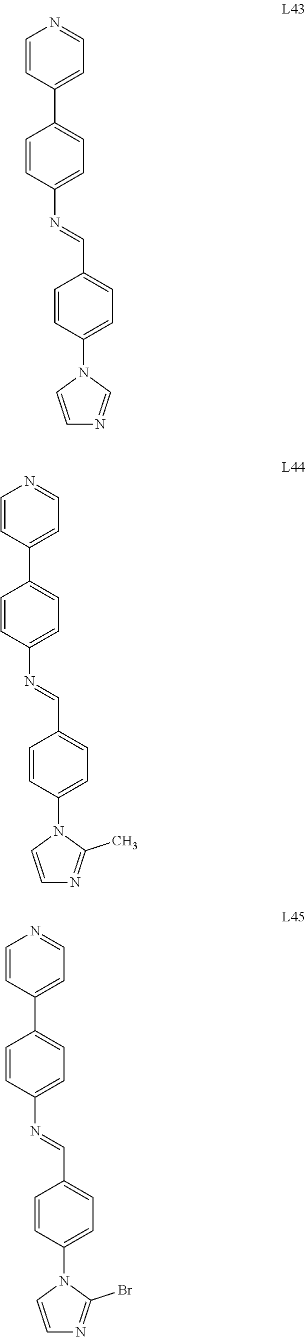 [SMILES: C(=N\c1ccc(-c2ccncc2)cc1)/c1ccc(-n2ccnc2)cc1 ; Cc1nccn1-c1ccc(/C=N/c2ccc(-c3ccncc3)cc2)cc1 ; Brc1nccn1-c1ccc(/C=N/c2ccc(-c3ccncc3)cc2)cc1]

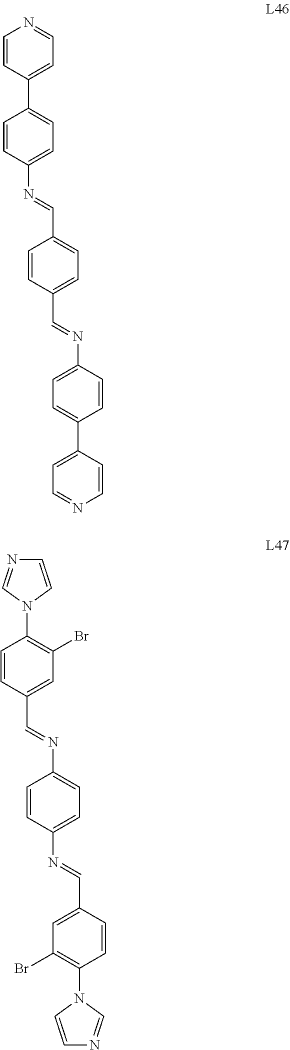 [SMILES: C(=N\c1ccc(-c2ccncc2)cc1)/c1ccc(/C=N/c2ccc(-c3ccncc3)cc2)cc1 ; Brc1cc(/C=N/c2ccc(/N=C/c3ccc(-n4ccnc4)c(Br)c3)cc2)ccc1-n1ccnc1]

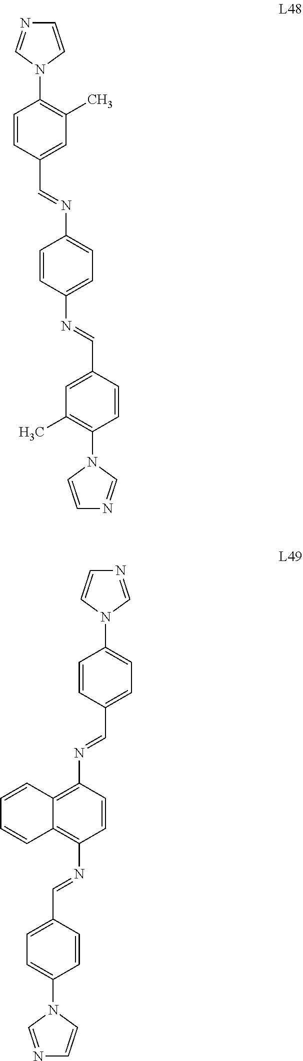 [SMILES: Cc1cc(/C=N/c2ccc(/N=C/c3ccc(-n4ccnc4)c(C)c3)cc2)ccc1-n1ccnc1 ; C(=N\c1ccc(/N=C/c2ccc(-n3ccnc3)cc2)c2ccccc12)/c1ccc(-n2ccnc2)cc1]

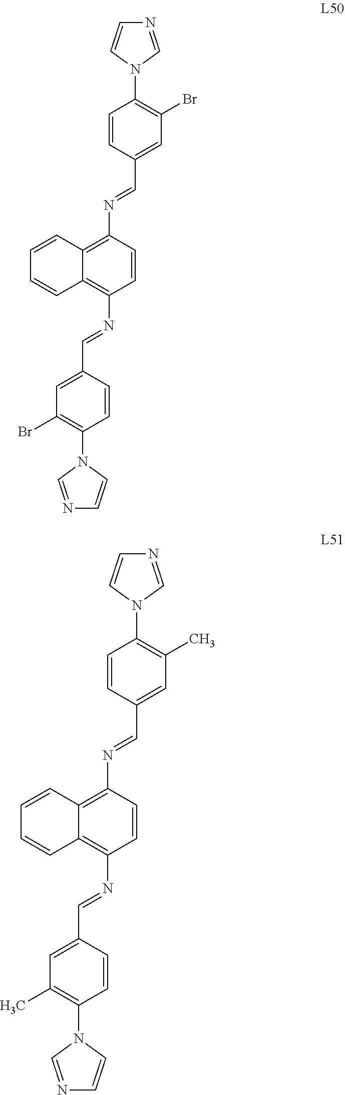 [SMILES: Brc1cc(/C=N/c2ccc(/N=C/c3ccc(-n4ccnc4)c(Br)c3)c3ccccc23)ccc1-n1ccnc1 ; Cc1cc(/C=N/c2ccc(/N=C/c3ccc(-n4ccnc4)c(C)c3)c3ccccc23)ccc1-n1ccnc1]

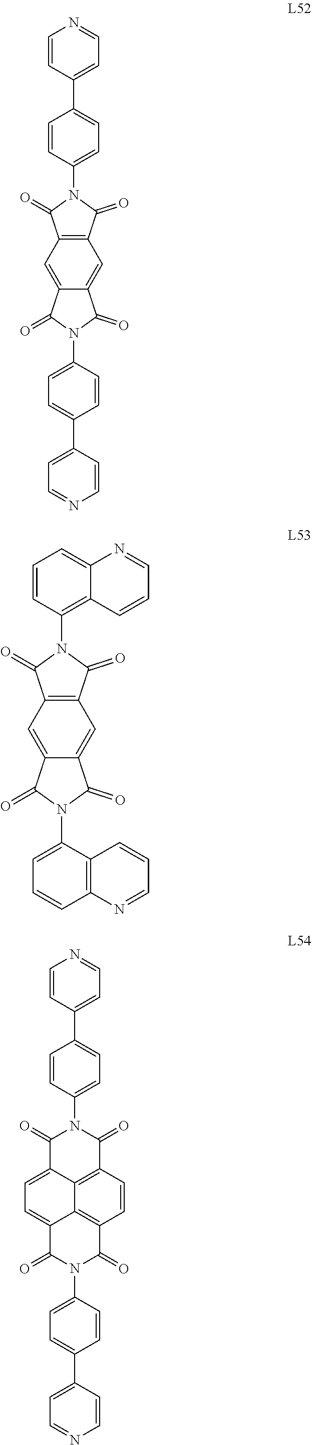 [SMILES: O=c1c2cc3c(=O)n(-c4ccc(-c5ccncc5)cc4)c(=O)c3cc2c(=O)n1-c1ccc(-c2ccncc2)cc1 ; O=c1c2cc3c(=O)n(-c4cccc5ncccc45)c(=O)c3cc2c(=O)n1-c1cccc2ncccc12 ; O=C1c2ccc3c4c(ccc(c24)C(=O)N1c1ccc(-c2ccncc2)cc1)C(=O)N(c1ccc(-c2ccncc2)cc1)C3=O]

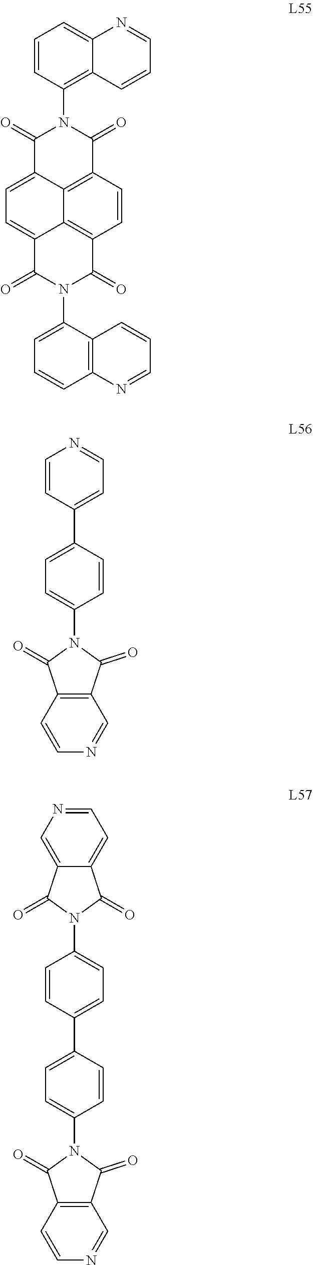 [SMILES: O=C1c2ccc3c4c(ccc(c24)C(=O)N1c1cccc2ncccc12)C(=O)N(c1cccc2ncccc12)C3=O ; O=C1c2ccncc2C(=O)N1c1ccc(-c2ccncc2)cc1 ; O=C1c2ccncc2C(=O)N1c1ccc(-c2ccc(N3C(=O)c4ccncc4C3=O)cc2)cc1]

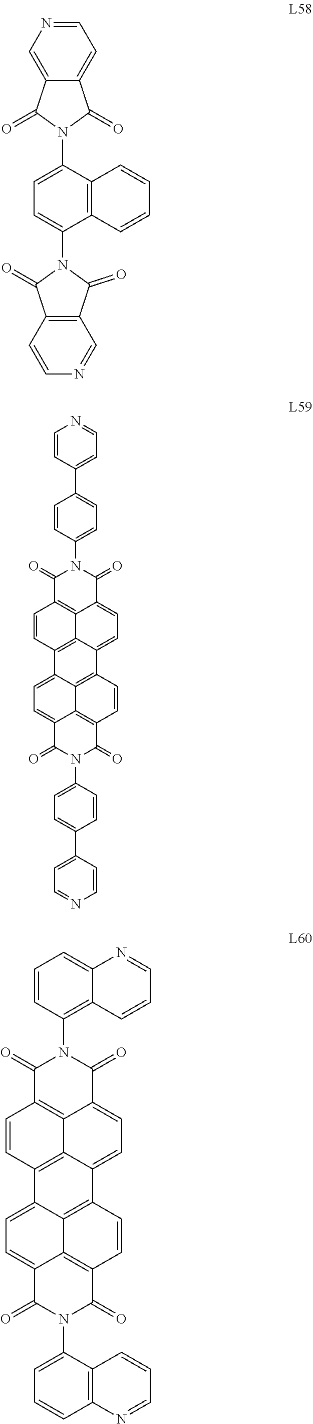 [SMILES: O=C1c2ccncc2C(=O)N1c1ccc(N2C(=O)c3ccncc3C2=O)c2ccccc12 ; O=C1c2ccc3c4ccc5c6c(ccc(c7ccc(c2c37)C(=O)N1c1ccc(-c2ccncc2)cc1)c64)C(=O)N(c1ccc(-c2ccncc2)cc1)C5=O ; O=C1c2ccc3c4ccc5c6c(ccc(c7ccc(c2c37)C(=O)N1c1cccc2ncccc12)c64)C(=O)N(c1cccc2ncccc12)C5=O]

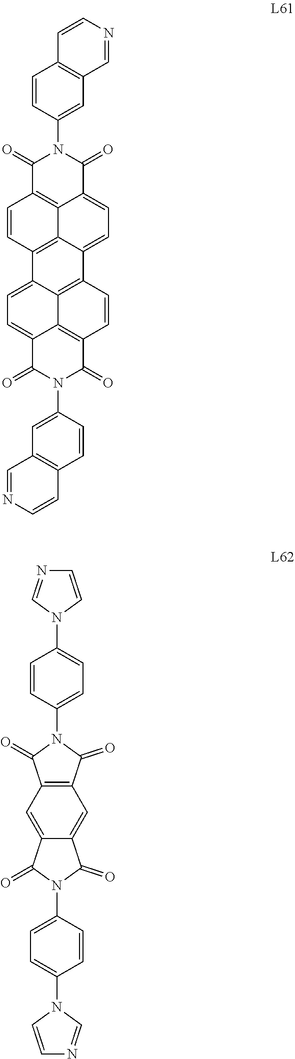 [SMILES: O=C1c2ccc3c4ccc5c6c(ccc(c7ccc(c2c37)C(=O)N1c1ccc2ccncc2c1)c64)C(=O)N(c1ccc2ccncc2c1)C5=O ; O=c1c2cc3c(=O)n(-c4ccc(-n5ccnc5)cc4)c(=O)c3cc2c(=O)n1-c1ccc(-n2ccnc2)cc1]

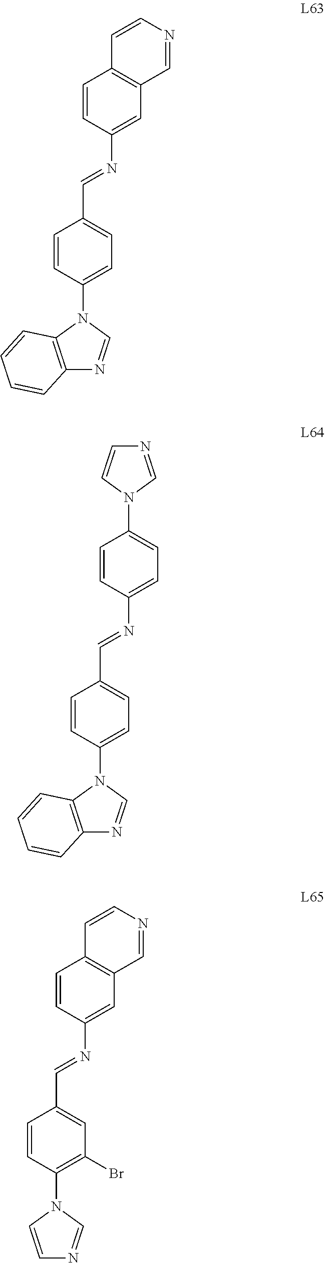 [SMILES: C(=N\c1ccc2ccncc2c1)/c1ccc(-n2cnc3ccccc32)cc1 ; C(=N\c1ccc(-n2ccnc2)cc1)/c1ccc(-n2cnc3ccccc32)cc1 ; Brc1cc(/C=N/c2ccc3ccncc3c2)ccc1-n1ccnc1]

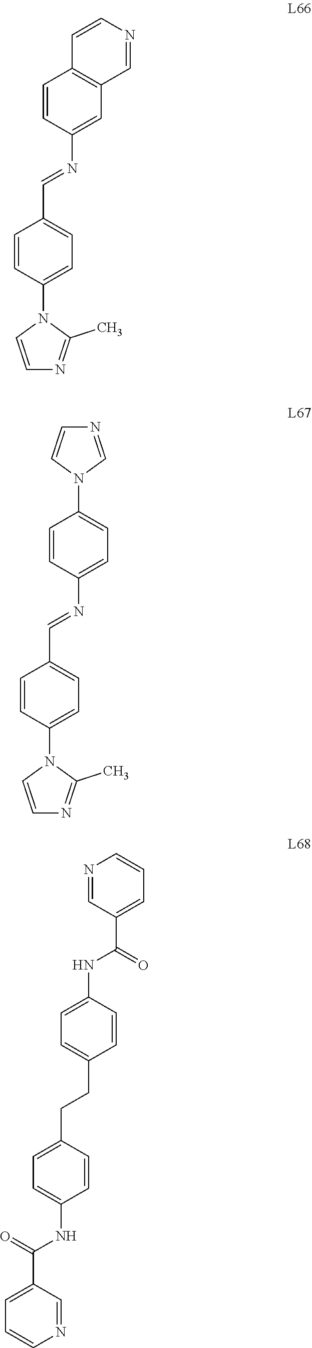 [SMILES: Cc1nccn1-c1ccc(/C=N/c2ccc3ccncc3c2)cc1 ; Cc1nccn1-c1ccc(/C=N/c2ccc(-n3ccnc3)cc2)cc1 ; O=C(Nc1ccc(CCc2ccc(NC(=O)c3cccnc3)cc2)cc1)c1cccnc1]

Preferred bidentate ligands for use herein include compounds (L1) to (L10) listed above.

Preferred bidentate nitrogen ligands for use herein include 4,4′-bipyridine (L1), 1,4-bis(4-pyridyl)benzene (L2), 4,4′-(2,5-dimethyl-1,4-phenylene)dipyridine (L3), 1,4-bis(4-pyridyl)biphenyl (L4) and 1,2-di(pyridine-4-yl)ethene (L5).

Especially preferred bidentate nitrogen ligands for use herein include 4,4′-bipyridine (L1), 1,4-bis(4-pyridyl)benzene (L2), 4,4′-(2,5-dimethyl-1,4-phenylene)dipyridine (L3) and 1,4-bis(4-pyridyl)biphenyl (L4).

Most preferably the bidentate nitrogen ligand is 4,4′-bipyridine (L1) or 1,4-bis(4-pyridyl)biphenyl (L4).

In some preferred embodiments the metal-organic material comprises an organic multidentate ligand having at least one donor nitrogen atom and one or more carboxylic acid residues. Preferred compounds of this type include at least one nitrogen containing aromatic ring. Such compounds may be referred to herein as nitrogen-carboxylate ligands.

Other suitable compounds of this type include those based on other nitrogen containing aromatic heterocycles, which may contain one or more nitrogen atoms and optionally one or more further heteroatoms, for example, imidazole, pyrimidine, pyrrole, pyrazole, isoxazole and oxazole. Also suitable are compounds based on bicyclic aromatic heterocycles, for example indole, purine, isoindole, pteridine, quinoline, benzotriazole and isoquinoline.

Suitable nitrogen-carboxylate ligands include compounds of formula L69 to L128:

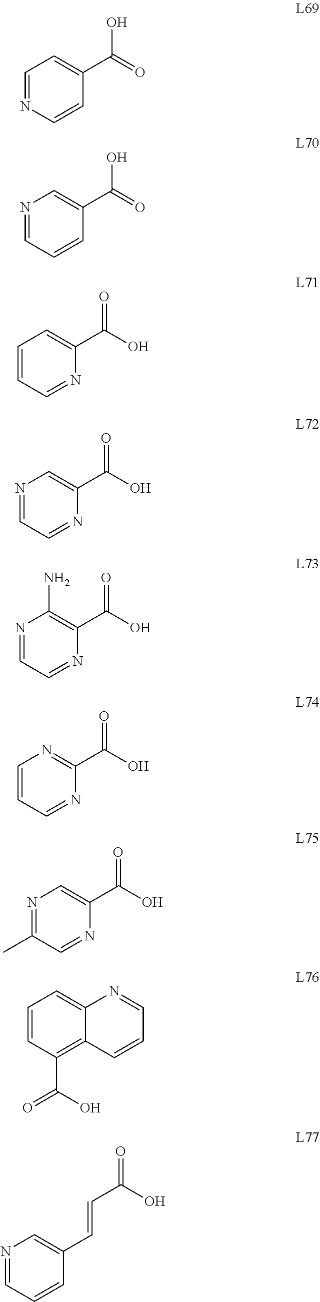

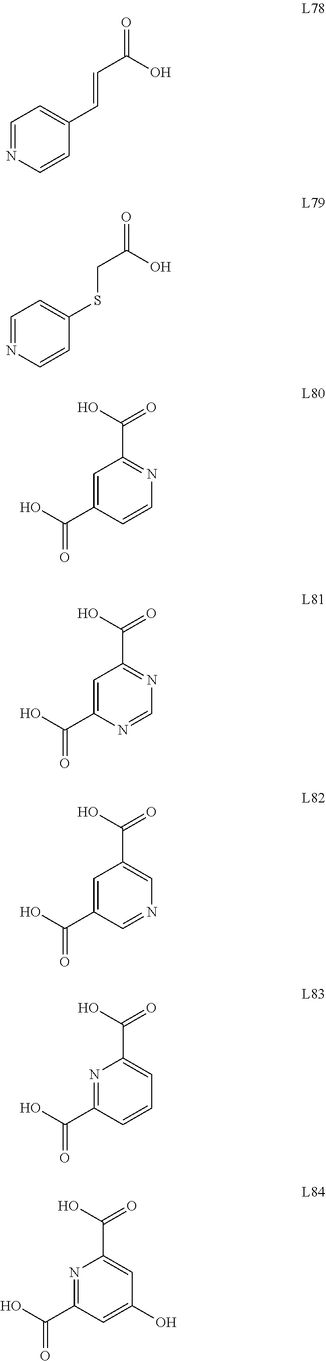

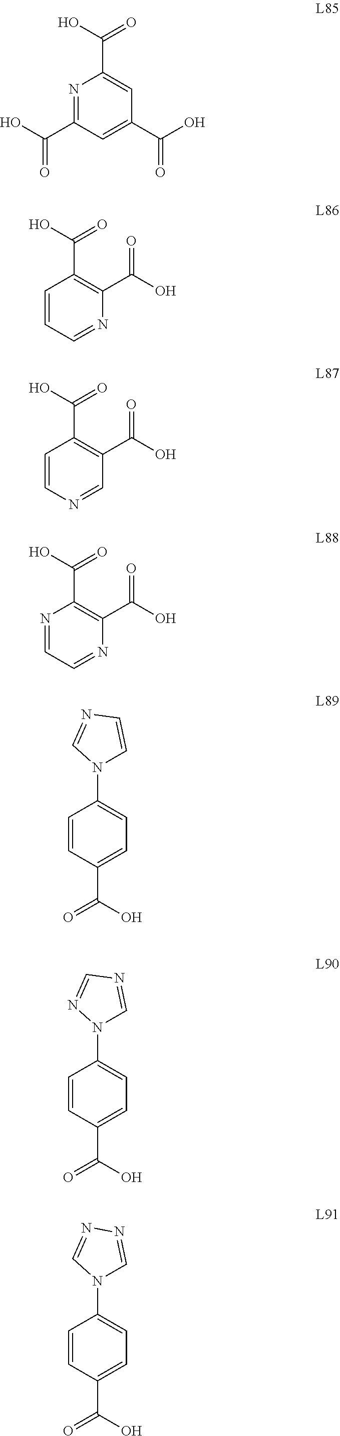

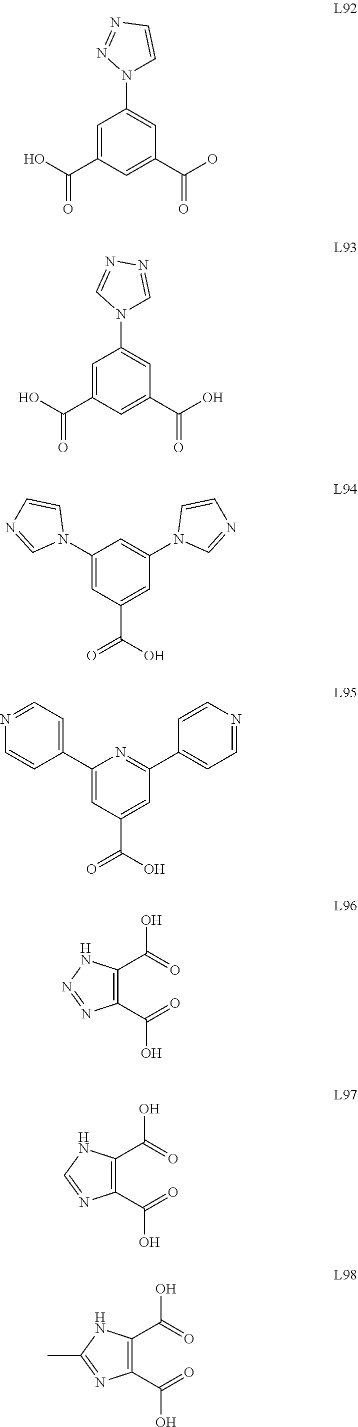

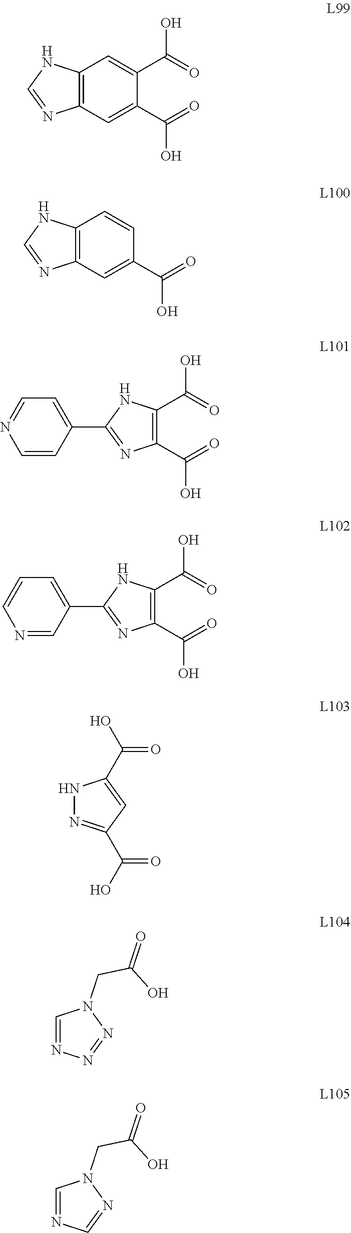

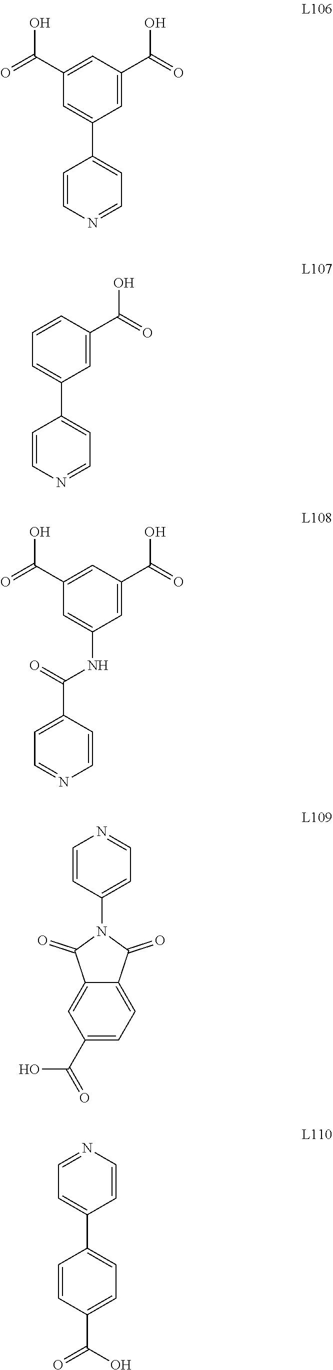 [SMILES: O=C(O)c1cc(C(=O)O)cc(-c2ccncc2)c1 ; O=C(O)c1cccc(-c2ccncc2)c1 ; O=C(O)c1cc(NC(=O)c2ccncc2)cc(C(=O)O)c1 ; O=C(O)c1ccc2c(c1)C(=O)N(c1ccncc1)C2=O ; O=C(O)c1ccc(-c2ccncc2)cc1]

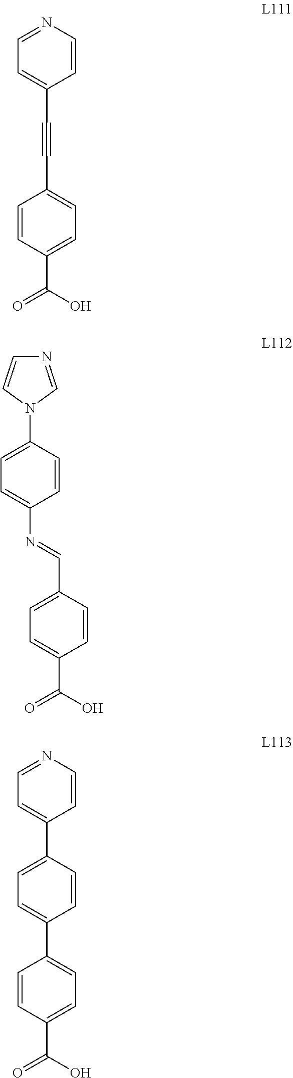 [SMILES: O=C(O)c1ccc(C#Cc2ccncc2)cc1 ; O=C(O)c1ccc(/C=N/c2ccc(-n3ccnc3)cc2)cc1 ; O=C(O)c1ccc(-c2ccc(-c3ccncc3)cc2)cc1]

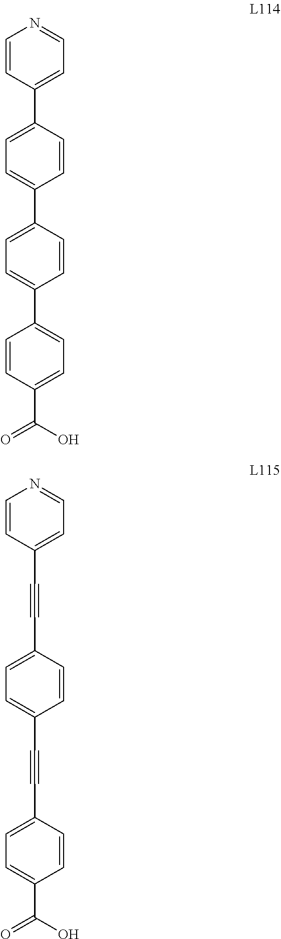 [SMILES: O=C(O)c1ccc(-c2ccc(-c3ccc(-c4ccncc4)cc3)cc2)cc1 ; O=C(O)c1ccc(C#Cc2ccc(C#Cc3ccncc3)cc2)cc1]

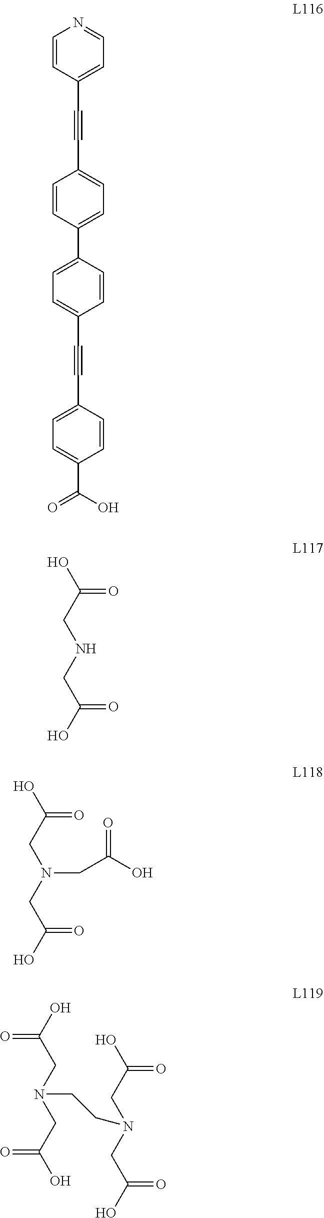 [SMILES: O=C(O)c1ccc(C#Cc2ccc(-c3ccc(C#Cc4ccncc4)cc3)cc2)cc1 ; O=C(O)CNCC(=O)O ; O=C(O)CN(CC(=O)O)CC(=O)O ; O=C(O)CN(CCN(CC(=O)O)CC(=O)O)CC(=O)O]

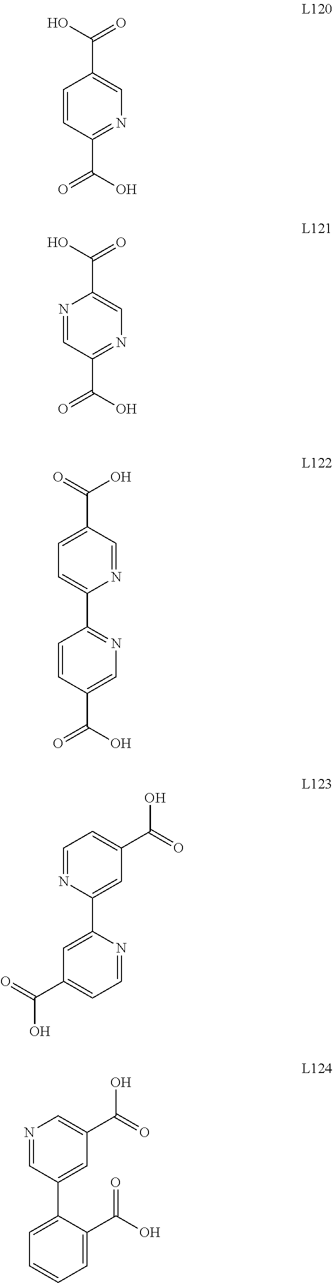 [SMILES: O=C(O)c1ccc(C(=O)O)nc1 ; O=C(O)c1cnc(C(=O)O)cn1 ; O=C(O)c1ccc(-c2ccc(C(=O)O)cn2)nc1 ; O=C(O)c1ccnc(-c2cc(C(=O)O)ccn2)c1 ; O=C(O)c1cncc(-c2ccccc2C(=O)O)c1]

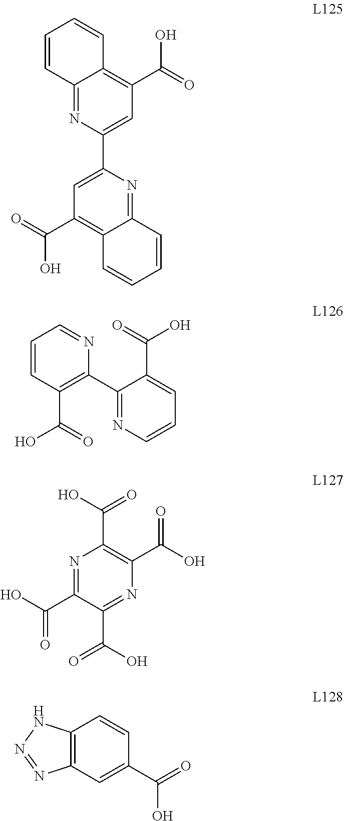

Preferred ligands of this type include benzotriazole-5-carboxylic acid (L128) and 2,4-pyridinedicarboxylic acid (L80).

In some preferred embodiments the metal-organic material comprises an organic multidentate ligand having at least two carboxylic acid residues. These compounds may be referred to herein as polycarboxylate ligands.

Suitable polycarboxylate ligands include compounds of formula L129 to L198:

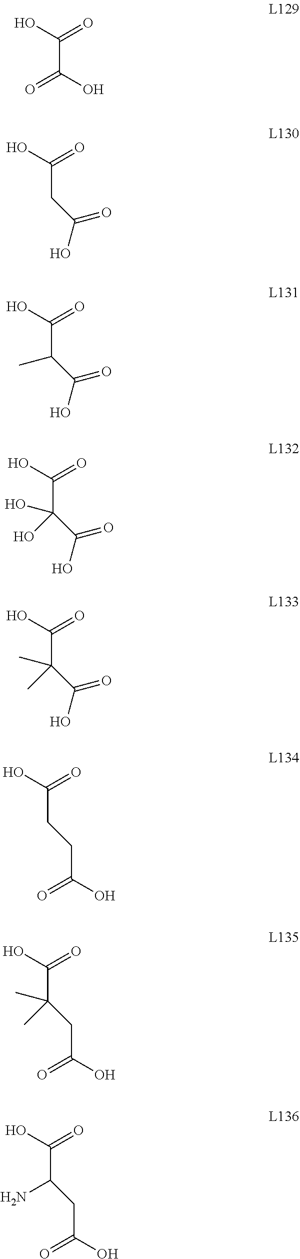

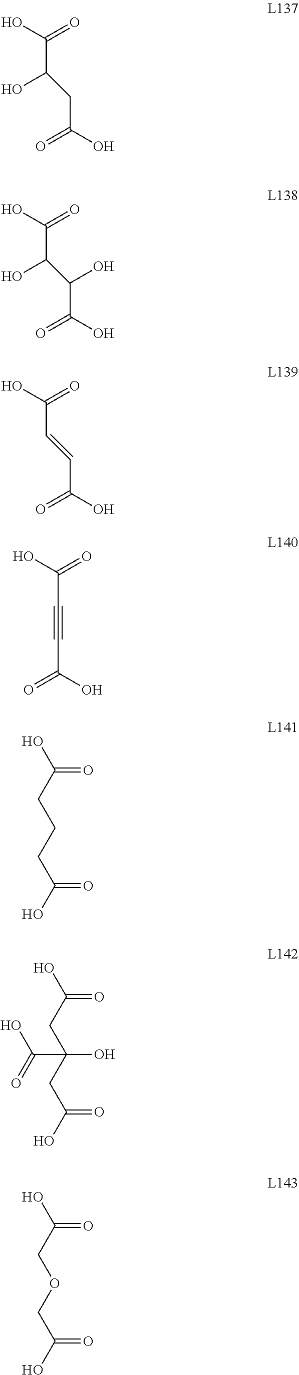

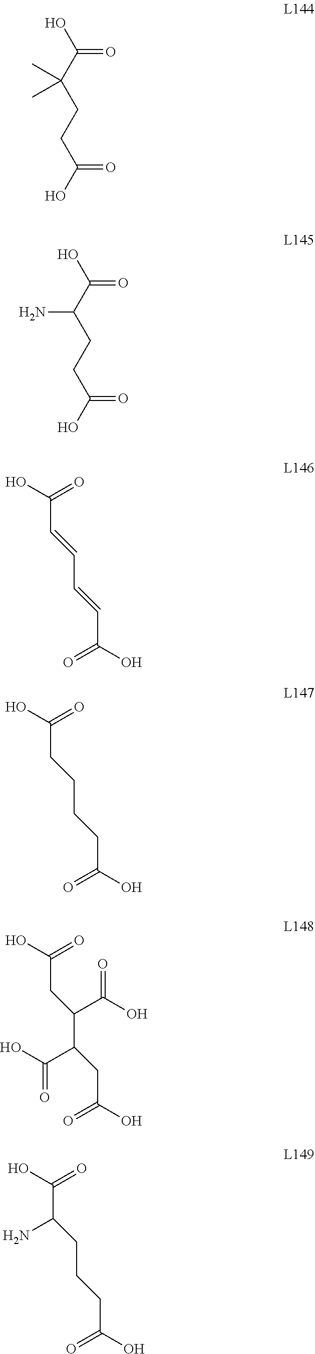

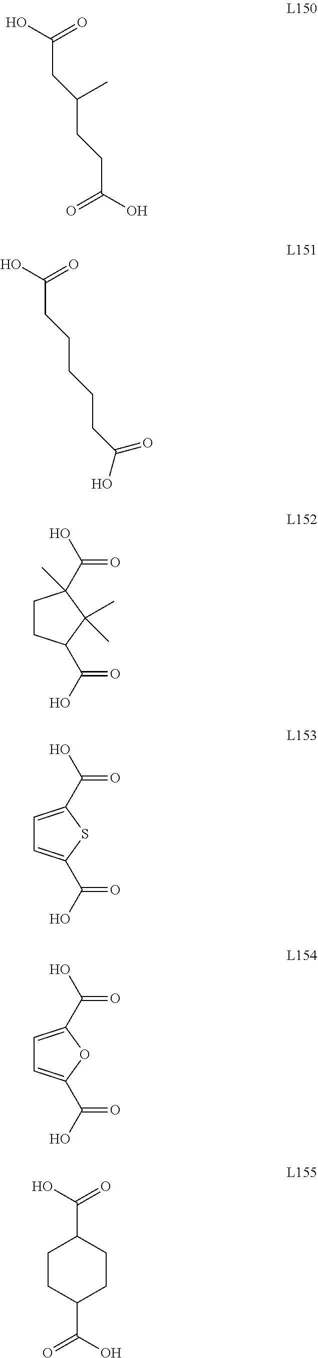

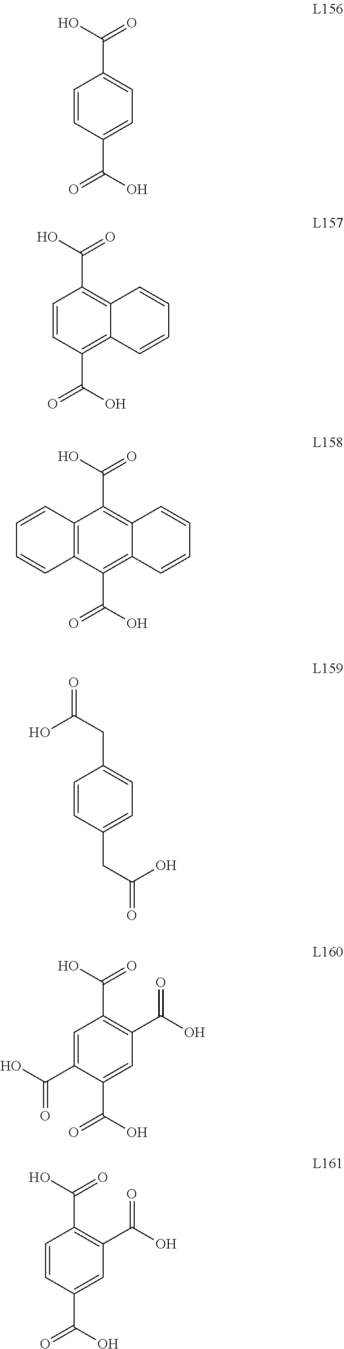 [SMILES: O=C(O)c1ccc(C(=O)O)cc1 ; O=C(O)c1ccc(C(=O)O)c2ccccc12 ; O=C(O)c1c2ccccc2c(C(=O)O)c2ccccc12 ; O=C(O)Cc1ccc(CC(=O)O)cc1 ; O=C(O)c1cc(C(=O)O)c(C(=O)O)cc1C(=O)O ; O=C(O)c1ccc(C(=O)O)c(C(=O)O)c1]

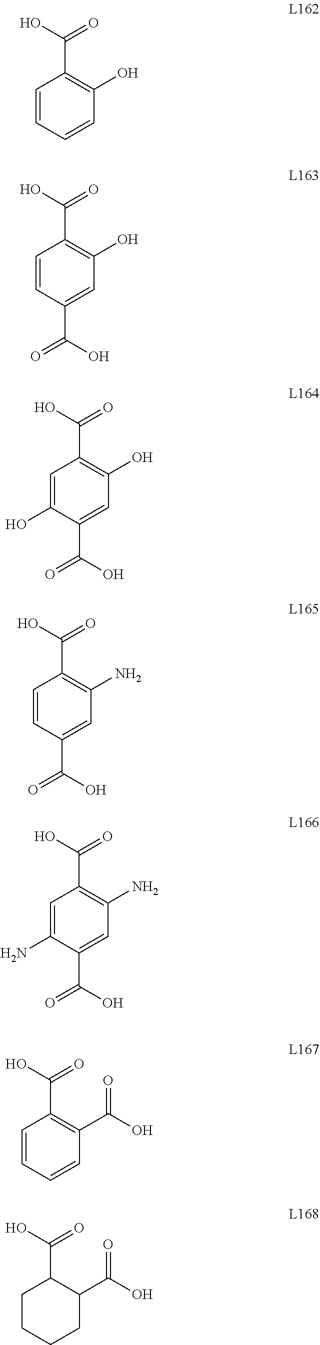

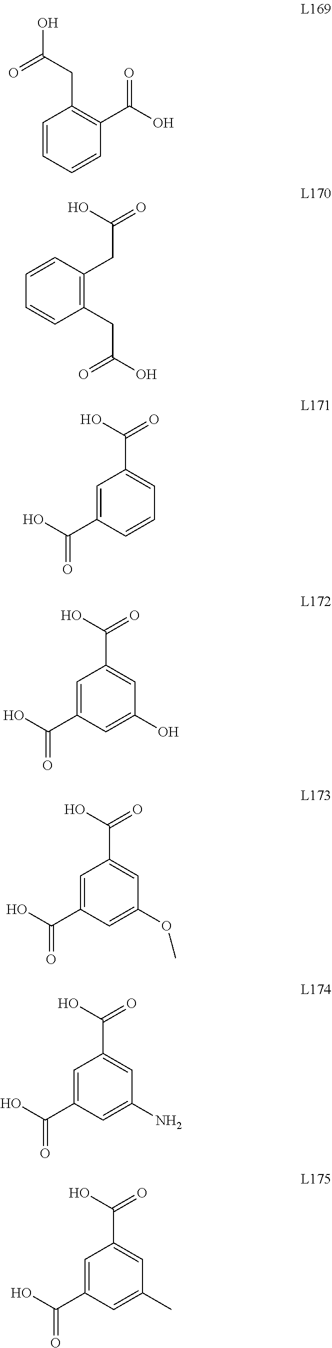

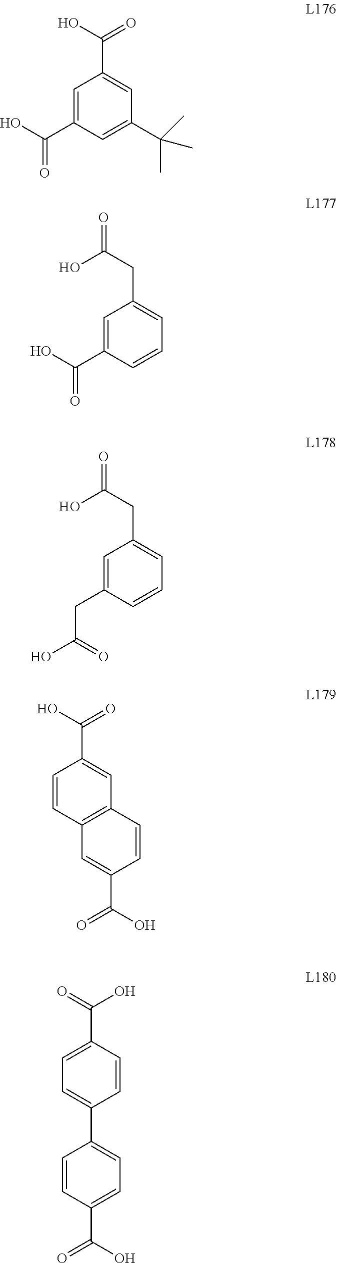 [SMILES: CC(C)(C)c1cc(C(=O)O)cc(C(=O)O)c1 ; O=C(O)Cc1cccc(C(=O)O)c1 ; O=C(O)Cc1cccc(CC(=O)O)c1 ; O=C(O)c1ccc2cc(C(=O)O)ccc2c1 ; O=C(O)c1ccc(-c2ccc(C(=O)O)cc2)cc1]

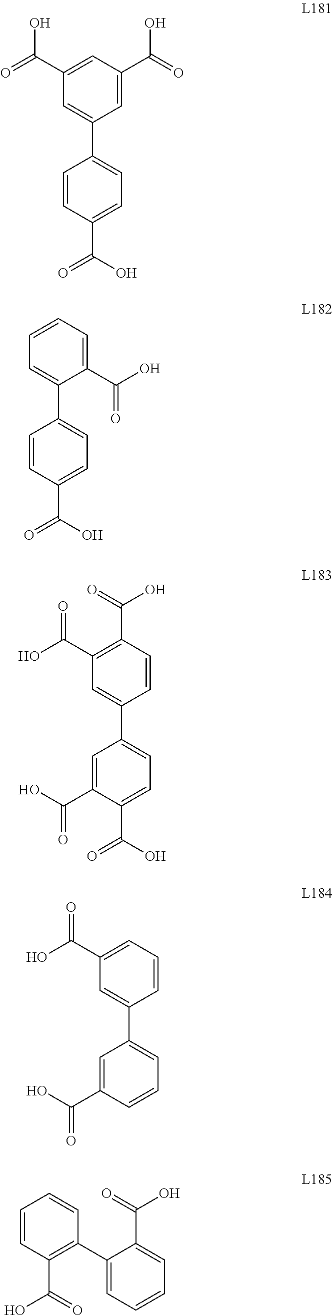

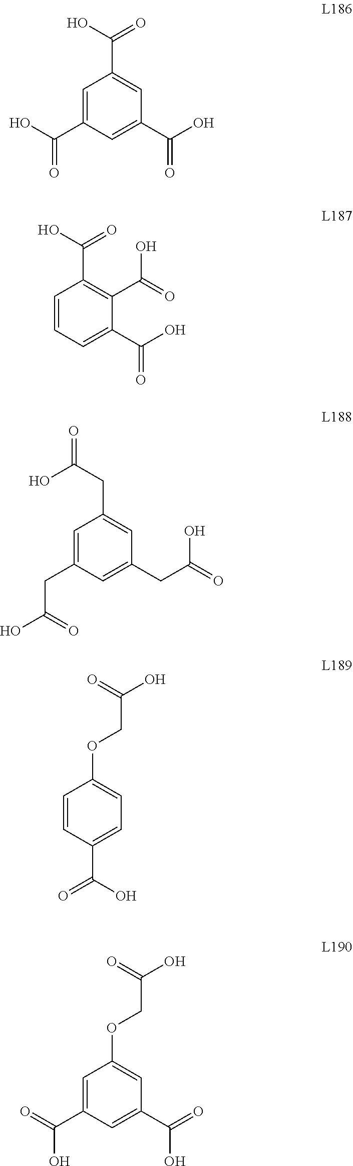 [SMILES: O=C(O)c1cc(C(=O)O)cc(C(=O)O)c1 ; O=C(O)c1cccc(C(=O)O)c1C(=O)O ; O=C(O)Cc1cc(CC(=O)O)cc(CC(=O)O)c1 ; O=C(O)COc1ccc(C(=O)O)cc1 ; O=C(O)COc1cc(C(=O)O)cc(C(=O)O)c1]

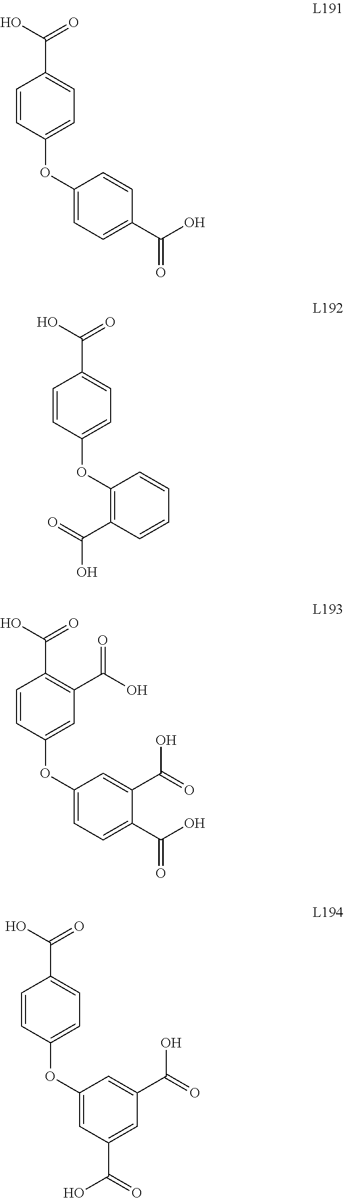 [SMILES: O=C(O)c1ccc(Oc2ccc(C(=O)O)cc2)cc1 ; O=C(O)c1ccc(Oc2ccccc2C(=O)O)cc1 ; O=C(O)c1ccc(Oc2ccc(C(=O)O)c(C(=O)O)c2)cc1C(=O)O ; O=C(O)c1ccc(Oc2cc(C(=O)O)cc(C(=O)O)c2)cc1]

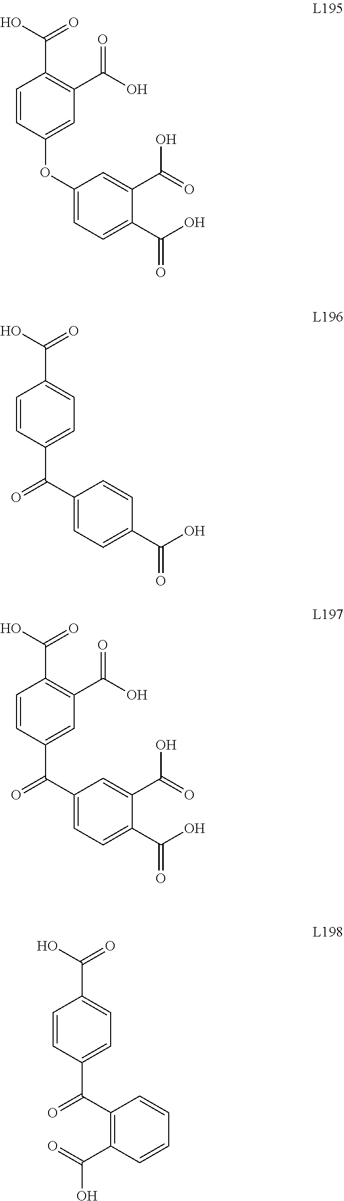 [SMILES: O=C(O)c1ccc(Oc2ccc(C(=O)O)c(C(=O)O)c2)cc1C(=O)O ; O=C(O)c1ccc(C(=O)c2ccc(C(=O)O)cc2)cc1 ; O=C(c1ccc(C(=O)O)c(C(=O)O)c1)c1ccc(C(=O)O)c(C(=O)O)c1 ; O=C(O)c1ccc(C(=O)c2ccccc2C(=O)O)cc1]

Preferred ligands of this type include glutaric acid (L141) and benzene-1,4-dicarboxylic acid (L156).

Step (a) of the method of the first aspect of the invention involves providing a metal-organic material.

The metal-organic material suitably comprises metal species and ligands. It may further comprise one or more anions.

Thus in some embodiments the metal-organic material comprises metal species, ligands and anions.

The anions may be coordinated to the metal species (as ligands) or may be incorporated elsewhere in the lattice.

Any suitable anions may be included. Suitable anions will be known to the person skilled in the art and include, for example, hydroxide, halide, carboxylate, nitrate, nitrite, sulfate, sulfite, phosphate, phosphite, borate, oxide, fluro oxyanion, triflate, complex oxyanion, chlorate, bromate, iodate, nitride, tetrafluoroborate, hexafluorophosphate, cyanate and isocyanate.

The metal-organic material may optionally comprise in one of its structural forms one or more solvent moieties. The solvent moiety may be water, an alcohol or other small organic molecule, for example a hydrocarbon compound, an oxygenated hydrocarbon or a halogenated carbon. Preferred solvent moieties include water, methanol, ethanol and α,α,α-trifluorotoluene.

Suitably the solvent species may form a coordination bond such as a coordinate covalent bond with the metal species or may be incorporated elsewhere in the lattice.

It will be appreciated by the skilled person that solvent molecules may be present in the crystal structure of the metal-organic material as a result of its preparation process. However the active material used to capture water preferably does not contain any solvent molecules within its crystal structure.

Two classes of metal-organic materials have been found by the present invention to be especially useful for capturing water from air. The first class of materials are porous metal-organic framework materials comprising pores which have a hydrophobic pore window and a hydrophilic internal pore surface. The second class of materials are two-dimensional layered materials. Each of these classes of material will now be further described.

Porous Metal-Organic Framework Materials

In some embodiments the present invention involves the use of porous metal-organic framework materials comprising pores which have a hydrophobic pore window and a hydrophilic internal pore surface. Thus the present invention may suitably provide the use of a porous metal-organic framework material comprising pores which have a hydrophobic pore window and a hydrophilic internal pore surface to capture water from air.

Hydrophobic atoms have absolute value of δ charge close to 0, while hydrophilic atoms have large absolute value of δ charge. Examples of hydrophobic atoms are H and C atoms in aliphatic or aromatic hydrocarbons. Examples of hydrophilic moieties are —OH, —NH₂ groups.

Pore shapes of porous materials are generally complex and cannot be fitted to simple geometric shapes (e.g. cube, sphere). One of the possible approximations to describe the pore shapes is to use sizes of the spheres that could be inscribed into the pores. Using this approach, the pore diameter 2 can be determined as the diameter of the largest included sphere that can fit in the pore. The pore window size 1 can be determined as the diameter of the largest free sphere that can be inscribed in the pore. This is illustrated in FIG. 33, which also shows the internal surface of the pore 3 (the pore wall). For the preferred porous materials of the present invention the internal surface is substantially hydrophilic in nature and the outer surface 4 of the pore window is substantially hydrophobic in nature.

The porous metal-organic framework materials suitable for use herein are preferably microporous materials. Microporous materials have pore diameters of less than 2 nm. Preferably the porous metal-organic framework materials have a pore diameter of less than 10 Å, more preferably less than 8 Å, for example less than 7.5 Å.

The porous metal-organic framework materials for use herein comprise metal species and ligands as previously described.

Suitably the porous metal-organic framework materials comprise a metal species and one or more ligands.

Preferably the metal species is selected from copper, cobalt, nickel, iron, zinc, cadmium, zirconium, magnesium, calcium and aluminium.

More preferably the metal species is selected from Cu²⁺, Co²⁺, Ni²⁺, Fe²⁺, Fe³⁺, Zn²⁺, Cd²⁺, Zr⁴⁺, Mg²⁺, Ca²⁺ and Al³⁺.

Preferably the metal species for the porous metal-organic framework material is selected from transition metals and magnesium.

Most preferably the metal species for the porous metal-organic framework material is selected from copper, cobalt, zirconium, zinc and magnesium.

Ligands useful for forming the porous metal-organic framework materials useful in the present invention preferably have one or more nitrogen donor atoms and/or one or more carboxylic acid (COOH) groups.

In some embodiments the porous metal-organic framework materials comprise two or more types of ligand.

Preferably the porous metal-organic framework materials include at least one ligand including a carboxylic acid residue.

In some preferred embodiments the porous metal-organic framework material includes a ligand including a nitrogen donor atom and a ligand including a COOH group. The nitrogen donor atom and the COOH group may be part of the same ligand or they may be provided by two different ligands.

The ligands of the porous metal-organic framework material are suitably selected from bidentate nitrogen ligands, nitrogen-carboxylate ligands and polycarboxylate ligands.

Preferred bidentate nitrogen ligands are selected from compounds L1 to L68 and especially compounds L1 to L5.

Preferred nitrogen-carboxylate ligands are selected from the compounds having the structures L69 to L128, and especially benzotriazole-5-carboxylic acid (L128) and 2,4-pyridinedicarboxylic acid (L80).

Preferred polycarboxylate ligands are selected from the compounds having the structures L129 to L198 and especially glutaric acid (L141) and benzene-1,4-dicarboxylic acid (L156).

Preferably the porous metal-organic framework materials used in the present invention include one or more ligands selected from 4,4′-bipyridine (L1), 1,2-di(pyridine-4-yl)-ethene (L5), glutaric acid (L141), benzotriazole-5-carboxylic acid (L128), 2,4-pyridinedicarboxylic acid (L80) and benzene-1,4-dicarboxylic acid (L156).

Preferably the porous metal-organic framework materials used in the present invention include one or more ligands selected from 4,4′-bipyridine (L1), 1,2-di(pyridine-4-yl)-ethene (L5), glutaric acid (L141), benzotriazole-5-carboxylic acid (L128), benzene-1,4-dicarboxylic acid (L156) and 2,4-pyridinedicarboxylic acid (L80).

Preferably the porous metal-organic framework material comprises a metal species selected from copper, zirconium, magnesium and cobalt and one or more ligands selected from 4,4′-bipyridine (L1), 1,2-di(pyridine-4-yl)-ethene (L5), glutaric acid (L141), benzotriazole-5-carboxylic acid (L128), benzene-1,4-dicarboxylic acid (L156) and 2,4-pyridinedicarboxylic acid (L80).

In some embodiments the porous metal-organic framework material comprises a metal species selected from copper and cobalt and one or more ligands selected from 4,4′-bipyridine (L1), 1,2-di(pyridine-4-yl)ethene (L5), glutaric acid (L141), benzotriazole-5-carboxylic acid (L128) and 2,4-pyridinedicarboxylic acid (L80).

In one embodiment the porous metal-organic framework material comprises Cu²⁺, 4,4′-bipyridine and glutarate. Water may be present in some crystal forms. This compound may be referred to herein as [Cu₂(glutarate)₂(4,4′-bipyridine)] or ROS-037.

In one embodiment the porous metal-organic framework material comprises Cu²⁺, 1,2-di(pyridine-4-yl)-ethene and glutarate. Water may be present in some crystal forms. This compound may be referred to herein as [Cu₂(glutarate)₂(1,2-di(pyridine-4-yl)ethene)] or AMK-059.

In one embodiment the porous metal-organic framework material comprises Co²⁺, 2,4-pyridinedicarboxylic acid and hydroxide. Water may be present in some crystal forms. This compound may be referred to herein as [Co₃(μ₃-OH)₂(2,4-pyridinedicarboxylate)₂] or Co-CUK-1.

In one embodiment the porous metal-organic framework material comprises Mg²⁺, 2,4-pyridinedicarboxylic acid and hydroxide. Water may be present in some crystal forms. This compound may be referred to herein as [Mg₃(μ₃-OH)₂(2,4-pyridinedicarboxylate)₂] or Mg-CUK-1.

In one embodiment the porous metal-organic framework material comprises Co²⁺, benzotriazole-5-carboxylic acid (H₂btca) and hydroxide. Water may be present in some crystal forms. This compound may be referred to herein as [Co₃(μ₃-OH)₂(benzotriazolate-5-carboxylate)₂].

In one embodiment the porous metal-organic framework material comprises Zr⁴⁺, benzene-1,4-dicarboxylic acid and hydroxide. Water may be present in some crystal forms. This compound may be referred to herein as [Zr₁₂O₈(μ₃-OH)₈(μ₂-OH)₆(benzene-1,4-dicarboxylate)₉] or hcp-UiO-66.

Suitably the porous metal-organic framework material is selected from [Cu₂(glutarate)₂(4,4′-bipyridine)], [Cu₂(glutarate)₂(1,2-di(pyridine-4-yl)ethene)], [Co₃(μ₃-OH)₂(2,4-pyridinedicarboxylate)₂], [Mg₃(μ₃-OH)₂(2,4-pyridinedicarboxylate)₂], [Co₃(μ₃-OH)₂(benzotriazolate-5-carboxylate)₂] and [Zr₁₂O₈(μ₃-OH)₈(μ₂-OH)₆(benzene-1,4-dicarboxylate)₉].

Two-Dimensional Layered Materials

A further class of metal-organic materials suitable for use in the present invention are two-dimensional layered materials. The two-dimensional layered materials of the invention comprise metal species and ligands as previously described herein.

By two-dimensional layered material we mean to refer to materials in which atoms, ions or molecules are chemically bonded in two dimensions to form layers.

The material will include multiple layers and weak intermolecular forces will exist between the layers. However strong bonding, such as coordinate covalent bonding, suitably is present in only two dimensions.

The two-dimensional layered material comprises metal species and ligands.

The metal species are suitably linked together by ligands in a first dimension and a second dimension.

Suitably the ligands link the metal species to form a two-dimensional layered framework.

In some embodiments the layers of the two-dimensional material are in the form of a honeycomb lattice.

In some preferred embodiments the first and second dimensions are substantially perpendicular to one another and the two-dimensional material comprises layers arranged in a square lattice.

Suitably the square lattice comprises a unit of formula (I):

wherein M represents the metal species and L represents a ligand.

Suitably the two-dimensional layered material comprises layers that are stacked on top of each other to create a three-dimensional lattice.

Suitably there is no intramolecular bonding between said layers. By intramolecular bonding we mean to refer to bonding such as covalent bonding, including coordinate covalent bonding.

Suitably there are intermolecular forces present between said layers. By intermolecular forces we mean to refer to forces such as hydrogen bonding, aromatic stacking interactions, permanent dipole-dipole interactions and London dispersion forces.

In some embodiments the two-dimensional layered material may comprise layers that are stacked directly on top of one another such that the metal species lie directly on top of one another when viewed from above, comprising a unit cell of formula (II):

wherein M represents the metal species and L represents the ligand.

Alternatively the two-dimensional layered material may comprise layers that are stacked on top of one another such that the metal species are offset from one another when viewed from above.

In preferred embodiments the metal species and ligands are in a square lattice arrangement.

In some embodiments the two-dimensional layered material comprises a transition metal species and a bidentate nitrogen ligand.

In some embodiments the two-dimensional layered material comprises a transition metal species and a bidentate nitrogen ligand selected from compounds L1 to L69.

In some embodiments the two-dimensional layered material comprises a transition metal species and a bidentate nitrogen ligand selected from compounds L1 to L4.

In some preferred embodiments the two-dimensional layered material comprises a metal species selected from copper, cobalt, nickel, iron, zinc and cadmium and a bidentate nitrogen ligand.

In preferred embodiments the two-dimensional layered material comprises a metal species selected from copper, cobalt and nickel and a bidentate nitrogen ligand.

In some especially preferred embodiments the two-dimensional layered material comprises a metal species selected from Cu²⁺, Co²⁺, Ni²⁺, Fe²⁺, Fe³⁺, Zn²⁺ and Cd²⁺ and a bidentate nitrogen ligand.

In especially preferred embodiments the two-dimensional layered material comprises a metal species selected from Cu²⁺, Co²⁺ and Ni²⁺ and a bidentate nitrogen ligand.

Preferably the two-dimensional layered material comprises a metal species selected from Cu²⁺, Co²⁺, Ni²⁺, Fe²⁺, Fe³⁺, Zn²⁺ and Cd²⁺ and a bidentate nitrogen ligand selected from compounds L1 to L69.

Preferably the two-dimensional layered material comprises a metal species selected from Cu²⁺, Co²⁺ and Ni²⁺ and a bidentate nitrogen ligand selected from compounds L1 to L69.

Suitably the two-dimensional layered material comprises a metal species selected from Cu²⁺, Co²⁺, Ni²⁺, Fe²⁺, Fe³⁺, Zn²⁺ and Cd²⁺ and a bidentate nitrogen ligand selected from compounds L1 to L4.

Suitably the two-dimensional layered material comprises a metal species selected from Cu²⁺, Co²⁺ and Ni²⁺ and a bidentate nitrogen ligand selected from compounds L1 to L4.

In some embodiments the two-dimensional layered material comprises Cu²⁺ and a bidentate nitrogen ligand selected from compounds L1 to L4.

In some embodiments the two-dimensional layered material comprises Co²⁺ and a bidentate nitrogen ligand selected from compounds L1 to L4.

In some embodiments the two-dimensional layered material comprises Ni²⁺ and a bidentate nitrogen ligand selected from compounds L1 to L4.

Suitably the two-dimensional layered material further comprises one or more anions.

The two-dimensional layered material suitably comprises metal species, ligands and anions. In preferred embodiments the metal species and ligands are in a square lattice arrangement.

The anions may be coordinated to the metal species (e.g. as ligands) or may be incorporated elsewhere in the lattice (e.g. as extra framework counterions).

Any suitable anions may be included. Suitable anions will be known to the person skilled in the art and include, for example, halide, carboxylate, nitrate, nitrite, sulfate, sulfite, phosphate, phosphite, borate, oxide, fluro oxyanion, triflate, complex oxyanion, chlorate, bromate, iodate, nitride, tetrafluoroborate, hexafluorophosphate, cyanate and isocyanate.

Most preferably the anions are selected from BF₄⁻, NO₃⁻, CF₃SO₃⁻ and glutarate.

In preferred embodiments the two-dimensional layered material comprises a metal species selected from Cu²⁺, Co²⁺ and Ni²⁺, a bidentate nitrogen ligand selected from compounds L1 to L4 and an anion selected from BF₄⁻, NO₃⁻, CF₃SO₃⁻ and glutarate.

In some especially preferred embodiments the two-dimensional layered material comprises Cu²⁺, 1,4-bis(4-pyridyl)biphenyl and BF₄⁻. This material may be referred to herein as sql-3-Cu—BF₄.

In one preferred embodiment the two-dimensional layered material comprises Cu²⁺, 1,4-bis(4-pyridyl)benzene and BF₄⁻. Water and ethanol may be included in some crystal forms. This material may be referred to herein as sql-2-Cu—BF₄.

In one embodiment the two-dimensional layered material comprises Cu²⁺, 1,4-bis(4-pyridyl)benzene and CF₃SO₃⁻. Water and ethanol may be present in some crystal forms. This material may be referred to herein as sql-2-Cu-OTf.

In one embodiment the two-dimensional layered material comprises Cu²⁺, 4,4′-bipyridine and NO₃⁻. TFT may be present in some crystal forms. This compound may be referred to herein as sql-1-Cu—NO₃.

In one embodiment the two-dimensional layered material comprises Cu²⁺, 4,4′-(2,5-dimethyl-1,4-phenylene)dipyridine and NO₃⁻. Water may be present in some crystal forms. This compound may be referred to herein as sql-A14-Cu—NO₃.

In one embodiment the two-dimensional layered material comprises Co²⁺, 4,4′-bipyridine and NO₃⁻. TFT may be present in some crystal forms. This material may be referred to herein as sql-1-Co—NO₃.

In one embodiment the two-dimensional layered material comprises Ni²⁺, 4,4′-bipyridine and NO₃⁻. TFT may be present in some crystal forms. This material may be referred to herein as sql-1-Ni—NO₃.

Suitably the two-dimensional layered material is selected from sql-3-Cu—BF₄, sql-2-Cu—BF₄, sql-2-Cu-OTf, sql-1-Cu—NO₃, sql-A14-Cu—NO₃, sql-1-Co—NO₃ and sql-1-Ni—NO₃.

The present invention relates to the use of metal-organic materials to capture water from air. These materials are suitably selected from porous metal-organic framework materials comprising pores which have a hydrophobic pore window and a hydrophilic internal pore surface and two-dimensional layered materials.

Especially preferred metal-organic materials for use herein include [Cu₂(glutarate)₂(4,4′-bipyridine)], [Cu₂(glutarate)₂(1,2-di(pyridine-4-yl)ethene)], [Co₃(μ₃-OH)₂(2,4-pyridinedicarboxylate)₂], [Mg₃(μ₃-OH)₂(2,4-pyridinedicarboxylate)₂], [Co₃(μ₃-OH)₂(benzotriazolate-5-carboxylate)₂], [Zr₁₂O₈(μ₃-OH)₈(μ₂-OH)₆(benzene-1,4-dicarboxylate)₉], sql-3-Cu—BF₄, sql-2-Cu—BF₄, sql-2-Cu-OTf, sql-1-Cu—NO₃, sql-A14-Cu-NO₃, sql-1-Co—NO₃ and sql-1-Ni—NO₃.

The present invention is characterised by metal-organic materials which switch from a first state to a second state upon contact with water and/or water vapour wherein the second state is able to retain a higher amount of water than the second state.

In some embodiments the switch from the first state to the second state may involve a change in the structure of the material. In other embodiments there is no change in the structure of the material itself, only in the amount of water it is able to hold.

Step (b) of the method of the first aspect of the present invention involves contacting the metal-organic material with water and/or water vapour.

By water we mean to refer to liquid water.

By water vapour we mean to refer to water in vapour form.

Atmospheric air typically comprises water vapour. This is present in various humidities depending on the environment.

Suitably the content of water vapour in the air may be defined in terms of absolute humidity (AH) or relative humidity (RH). Absolute humidity refers to the measure of water vapour in the air regardless of the temperature of the air. Relative humidity refers to the measure of water vapour in the air relative to the temperature of the air. Relative humidity is expressed as the amount of water vapour in the air as a percentage of the total maximum amount that could be held at a particular temperature.

Relative humidities (RH) of 0 to 30% are considered herein to be low, those of 30 to 60% are considered to be medium and those of greater than 60% are considered to be high.

Suitably step (b) involves providing sufficient water and/or water vapour to cause the metal-organic material to switch between the first state and the second state.

In preferred embodiments step (b) involves contacting the metal-organic material with water vapour.

Preferably step (b) involves contacting the metal-organic material with ambient air.

Suitably step (b) involves contacting the metal-organic material with ambient air of sufficient humidity to cause the material to switch between the first state and the second state.

The level of humidity needed to cause the material to switch between the first state and the second state will depend on the specific material.

In its second state the metal-organic material is able to retain a higher amount of water than in its first state.

Thus switching from the first state to the second state increases the amount of water the material can retain.

By the amount of water the material is able to retain we mean to refer to the amount of water the material is able to hold within its structure.

In some embodiments switching between the first state and the second state does not involve a change in the structure of the material but does involve a change in the amount of water that can be retained by the material. Thus the material may switch from an empty state to a loaded state.

For example, without being bound by theory, in embodiments in which the metal-organic material is a porous metal-organic framework material comprising pores having a hydrophobic window and a hydrophilic internal pore surface, it is believed that the presence of the hydrophobic pore windows prevents water uptake at low humidity. However once a threshold humidity is reached, water is freely able to enter the pores and the hydrophilic pore walls permit a significant increase in the amount of water the material is able to retain.

In some embodiments switching from the first state to the second state may lead to an increase in the porosity of the metal-organic material.

In embodiments in which the metal-organic material is a two-dimensional layered material, switching from the first state to the second state may involve a change in the structure of the material. When switching from the first state to the second state the two-dimensional layered material preferably changes to a more open structure. The first state may be regarded as a closed state or a closed phase and the second state may be regarded as an open state or an open phase.

In some embodiments the first state may be regarded as a closed state and the second state may be regarded as an open state.

In some embodiments the first state may be regarded as a lower porosity state and the second state may be regarded as a higher porosity state.

Porosity is a measure of empty space or voids in a material.

Suitably the two-dimensional layered material is able to sorb water in cavities within the layer, herein referred to as intrinsic porosity.

Alternatively the two-dimensional layered material is able to sorb water between said layers, herein referred to as extrinsic porosity.

Preferably the two-dimensional layered material displays both intrinsic and extrinsic porosity.

In some embodiments the two-dimensional layered materials of the present invention comprise pores with an area about 7.5 Å×7.5 Å.

Suitably the two-dimensional layered material has an interlayer distance of less than 5 Å.

In some embodiments switching between the first and second states of the metal-organic material occurs at low RH.

In some embodiments switching between the first and second states of the metal-organic material occurs at medium RH.

In some embodiments switching between the first and second states of the metal-organic material occurs at high RH.

The metal-organic material is able to retain a higher amount of water in its second state than in its first state. The water content retained by the metal-organic material may be measured as a percentage by weight relative to the weight of the material.

Suitably in its second state the metal-organic material can hold 5% (by weight) more water than in its first state, preferably at least 10% more, suitably at least 15% more.

In some embodiments the increase in the amount of water able to be retained by the metal-organic material is gradual. In other embodiments the increase is sudden.

Preferably a significant increase in the amount of water able to be retained by the metal-organic material occurs once a threshold humidity is reached. Suitably the amount of water able to be retained increases by at least 10%, preferably at least 20%, suitably at least 30% upon contact with water vapour of a threshold humidity, compared with the amount initially able to be retained.

The threshold humidity will depend on the particular metal-organic material.

In some embodiments the present invention may involve the use of a metal-organic material in a very dry environment (e.g. <10% RH). Suitable materials for use in such environments include sql-3-Cu—BF₄ and ROS-037.

The metal-organic material of the present invention can be used to capture water from air. In some embodiments it can be used to store water.

Water is suitably stored by the metal-organic material in its second state.

Suitably the metal-organic material may be able to store water for an extended period of time. For example the metal-organic material may be able to store water for several minutes. Suitably the metal-organic material may be able to store water for several hours.

In preferred embodiments water can be desorbed from the metal-organic material.

In preferred embodiments the metal-organic material can switch from the first state to the second state and from the second state to the first state.

In preferred embodiments the sorption and desorption processes occur at similar rates and follow a similar pathway. The hysteresis in the system is suitably small and there is preferably little difference between the adsorption threshold pressure and the desorption threshold pressure. The adsorption-desorption process is thus suitably reversible.

Suitably desorption occurs when the metal-organic material is subjected to a stimulus, for example a change in relative humidity or a change in temperature. Suitably desorption occurs upon subjecting the metal-organic material to reduced relative humidity and/or increased temperature.

In preferred embodiments such desorption is reversible.

In especially preferred embodiments sorption and desorption are reversible over several cycles.

Suitably the metal-organic material of the present invention has favourable kinetics of adsorption at or above the threshold humidity.

Suitably the metal-organic material of the present invention reaches at least 50% of its maximum capacity within 5 minutes under ambient conditions of temperature and humidity (27° C., 1 atm). Suitably the metal-organic material reaches at least 80%, for example 90%, of its maximum capacity within 10 minutes under ambient conditions of temperature and humidity. Suitably the metal-organic material may reach its capacity within 10 minutes under ambient conditions of temperature and humidity.

Suitably the metal-organic material has a water sorption capacity of at least 120 cm³ of water vapour at STP per cm³ of material. Suitably the metal-organic material has a water uptake of at least 130 cm³ of water vapour at STP per cm³ of material, for example at least 140 cm³ of water vapour at STP per cm³ of material. Suitably the metal-organic material has a water uptake of at least 150 cm³ cm³ of water vapour at STP per cm³ of material.

Suitably the water uptake may be determined using standard vacuum dynamic vapour sorption (DVS) or intrinsic dynamic vapour sorption methods. Such methods are well known to those skilled in the art.

Suitably the metal-organic material has favourable kinetics of adsorption below the threshold humidity.

Suitably the metal-organic material releases at least 120 cm³ water vapour/cm³ material when subjected to a stimulus such as a change in temperature or change in relative humidity. Suitably the metal-organic material releases at least 130 cm³ water vapour/cm³ material, for example at least 140 cm³ water vapour/cm³ material when subjected to a stimulus. Suitably the metal-organic material releases at least 150 cm³ water vapour/cm³ material when subjected to a stimulus.

Suitably the desorption occurs at a temperature of below 75° C. Suitably the desorption occurs at a temperature of below 70° C., for example below 65° C. Suitably the desorption occurs at a temperature of below 60° C.

The water provided by the present invention is suitably highly pure.

The fourth aspect of the present invention provides a device for capturing water from air comprising a metal-organic material as previously defined herein and a support.

The material is suitably arranged on the support in a configuration to ensure maximum sorption.

The metal-organic material may be arranged on the surface of the support or incorporated within the body of the support.

The support may be selected from any suitable polymeric, plastic, metal, resin and/or composite material. A person skilled in the art will be familiar with these types of material and will be able to select the most appropriate support for the device.

In some embodiments the support is a polymer material. In one embodiment the support comprises an acrylic polymer. Suitable acrylic polymers include commercially available HYCAR® 26410 from the Lubrizol Corporation.

In one embodiment the support comprises a cellulosic material, for example paper. The support may comprise a composite material of paper and another polymer.

Suitably the device comprises means for directing air flow through or across the metal-organic material.

In some embodiments the device may be electrically powered. Suitably it may be powered by renewable resources, for example solar power.

The device may optionally be used for water storage.

The device may optionally be used for water delivery.

Suitably the device may further comprise means for desorbing water from the metal-organic material.

Such means may suitably comprise means for exposing the metal-organic material to a temperature change and/or a pressure change.

The water delivered from the metal-organic material is suitably ultra-high purity water.

By ultra-high purity water we mean to refer to water without any contaminant species, such as organic and inorganic compounds and dissolved gases.

In some embodiments the water delivered from the metal-organic material may be gaseous ultra-high purity water.

Preferably the water delivered from the metal-organic material is liquid ultra-high purity water.

Suitably the water delivered from the metal-organic material may undergo treatment to make the water suitable for its specific use.

The water delivered from the metal-organic material may be used for drinking water. In such use, the water may involve a treatment step to make the water suitable for human consumption.

The water delivered from the metal-organic material may be used in agriculture.

The water delivered from the metal-organic material may be used in medical applications.

The water delivered from the metal-organic material may be used in industrial applications.

According to a fifth aspect of the present invention there is provided a method of delivering water to a locus from water vapour in the air, the method comprising the steps of:
(a) providing a metal-organic material;
(b) contacting the metal-organic material with water and/or water vapour such that the material switches from a first state to a second state wherein the second state is able to retain a higher amount of water than the first state;
(c) optionally transporting and/or storing the metal-organic material;
(d) applying a stimulus to the metal-organic material to effect desorption of water retained therein; and
(e) collecting desorbed water at the locus.

The method of the fifth aspect may be regarded as a method of harvesting water involving capture and then release.

According to a sixth aspect of the present invention there is provided the use of a metal-organic material of the third aspect or a device of the fourth aspect to deliver water to a locus.

The metal-organic materials of the present invention can also be used to capture water from liquid compositions comprising water and one or more further components. Such liquid compositions include aqueous composition comprising dissolved solids, for example sea water. Thus the metal-organic materials of the present invention can also be used in desalination methods.

One especially preferred material useful in the present invention is [Cu₂(glutarate)₂(4,4′-bipyridine)].

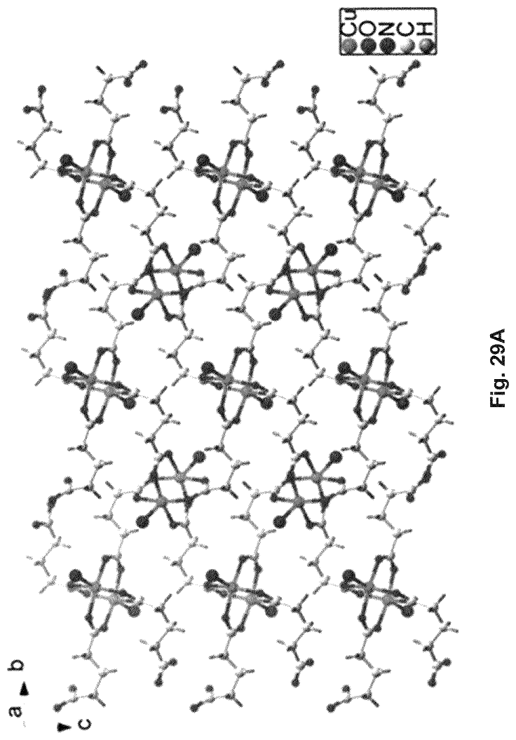

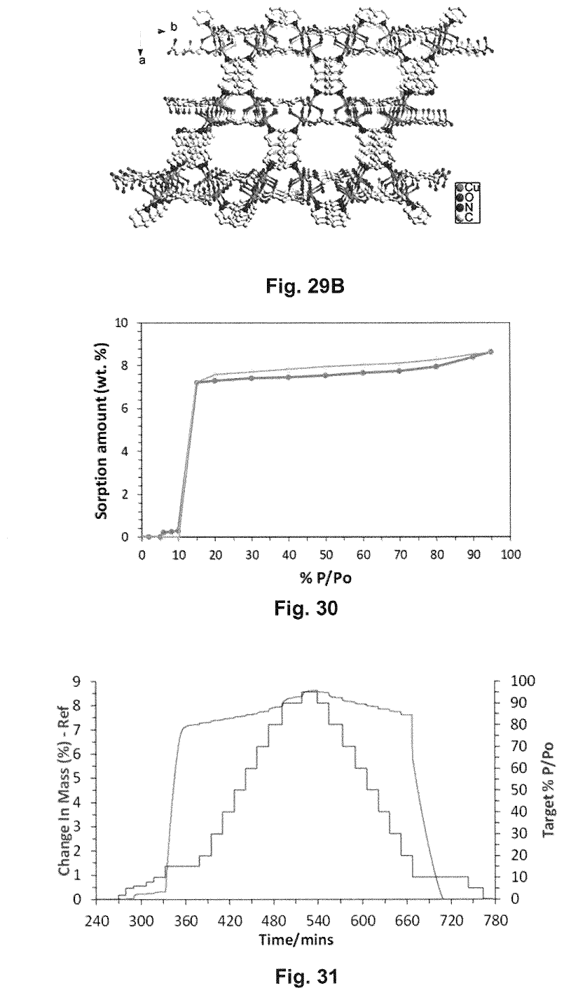

This material is also referred to herein and can be prepared in a number of ways. Methods of preparing this material are described in Examples 8, 9, 10 and 11 and its crystallographic structure is shown in FIGS. 29A and 29B.

This material is highly advantageous because it has favourable adsorption and desorption kinetics, under typical vacuum, temperature or humidity swing tests; suitable thermodynamics (desorption occurs below 75° C. at atmospheric pressure) and suitable working capacity (water vapour uptake of at least 150 cm³ water vapour/cm³ material).

The present invention may therefore provide a method of capturing water from air, the method comprising contacting [Cu₂(glutarate)₂(4,4′-bipyridine)] with water and/or water vapour.

The invention further provides the use of [Cu₂(glutarate)₂(4,4′-bipyridine)] to capture water from air.

The invention will now be further described by reference to the accompanying figures and examples.

In the following examples, powder X-ray diffraction (PXRD) measurements were taken using microcrystalline samples using a PANalytical Empyrean™ diffractometer equipped with a PIXcel3D detector. The variable temperature powder X-ray diffraction (VT-PXRD) measurements were collected using a Panalytical X'Pert diffractometer.

Single crystal X-ray diffraction (SCXRD) measurements were also collected on a number of compounds. The data was collected using a Bruker D8 Quest diffractometer.

Thermogravimetric analysis (TGA) was carried out under nitrogen using the instrument TA Q50 V20.13 Build 39 and data was collected in the high resolution dynamic mode.

Fourier Transform Infrared (FT-IR) spectra were measured on a Perkin Elmer spectrum 200 spectrometer.

Low-pressure N₂ adsorption measurements were performed on approximately 200 mg of sample using ultra-high purity grade N₂. The measurements were collected using a Micrometrics TriStar II PLUS and a Micrometrics 3 Flex was used to analyse the surface area and pore size.

Vacuum dynamic vapour sorption (DVS) studies made use of a Surface Measurement Systems DVS Vacuum, which gravimetrically measures the uptake and loss of vapour. The DVS methods were used for the determination of water vapour sorption isotherms using approximately 15 to 30 mg of sample. Pure water was used as the adsorbate for these measurements and temperature was maintained by enclosing the system in a temperature-controlled incubator.

### Water Adsorption Isotherm Classification

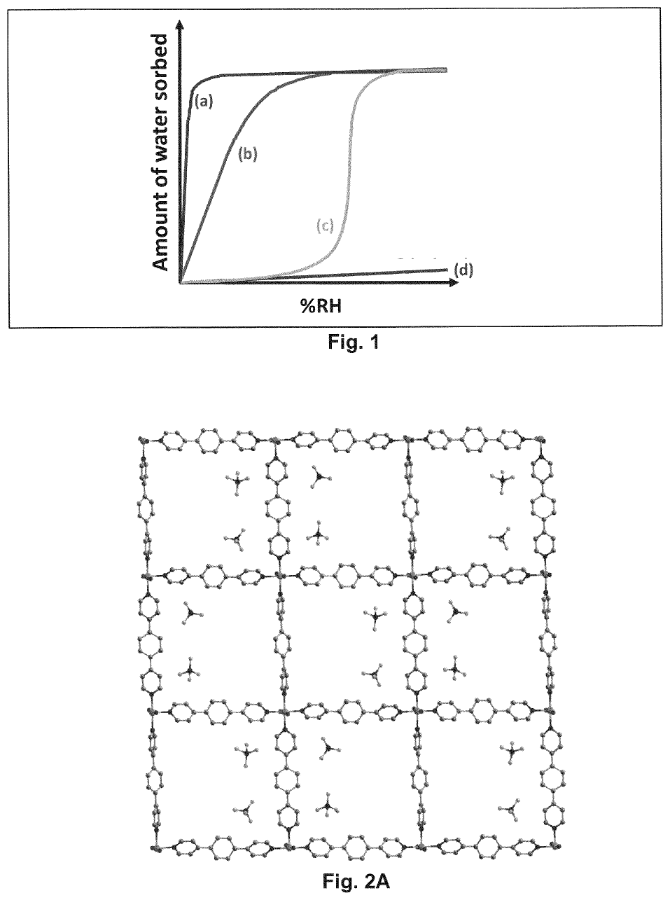

Preliminary evaluation of sorption performance in either adsorption or desorption events of sorbents is conducted by obtaining sorption isotherms. The isotherm reveals the amount of adsorbate (in this case water vapour) adsorbed and/or desorbed across a range of relative humidities (RHs) at a given temperature. FIG. 1 illustrates four types of water sorption. Such isotherms can be obtained using the instruments and methods known to those skilled in the art. Metal-organic materials for use in the present invention desirably have an isotherm as shown by line (c) of FIG. 1.

Examples 1 to 7 which follow are examples two-dimensional layered materials of the present invention.

The remaining examples relate to embodiments in which the metal-organic materials are porous metal-organic framework material comprising pores which have a hydrophobic pore window and a hydrophilic internal pore surface.

### EXAMPLE 1: sql-2-Cu—BF₄

Synthesis of sql-2-Cu—BF₄

An ethanol solution (3.0 ml) containing 1,4-bis(4-pyridyl)benzene (11.6 mg, 0.05 mmol) was slowly layered on an aqueous solution (3.0 ml) of copper(II) tetrafluoroborate (6 mg, 0.025 mmol) at room temperature. The resulting green crystals were collected by filtration with a yield of approximately 60%.

Structure of sql-2-Cu—BF₄

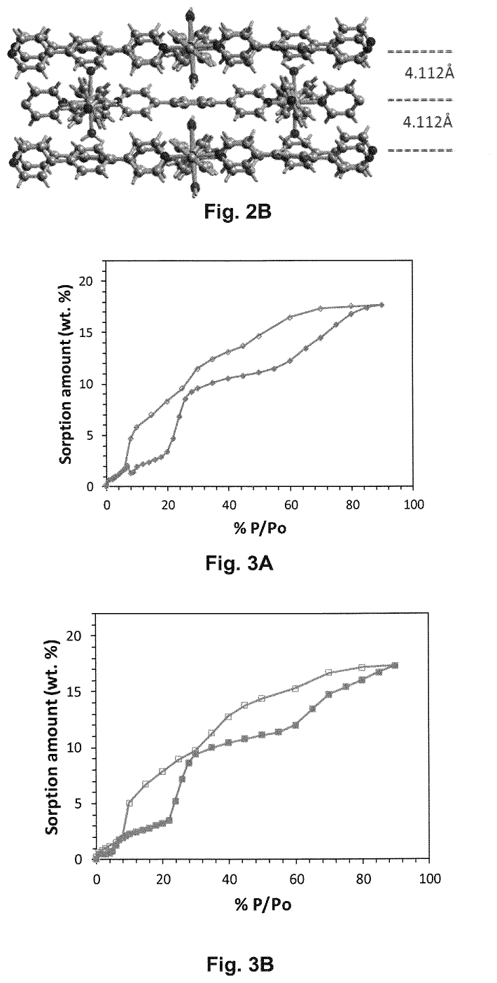

sql-2-Cu—BF₄ forms a two-dimensional layered network with Cu²⁺ ions connected in one and two dimensions by 1,4-bis(4-pyridyl)benzene to form a square lattice shown in FIG. 2A. The square lattice layers are stacked above one another with an interlayer separation of 4.112 Å shown in FIG. 2B. The guest accessible volume was found to be 16%. The synthesised phase contained two ethanol molecules and two water molecules in the lattice, and two coordinated water molecules.

Water Vapour Sorption Studies of sql-2-Cu—BF₄

Water sorption isotherms for sql-2-Cu—BF₄ were collected at 25° C. and 35° C., shown in FIG. 3A and FIG. 3B respectively. The isotherms demonstrated Type F-I isotherm characteristics, pointing to gradual adsorption behaviour from an open to more open phase. Sorption isotherms for both temperatures were repeated and the second sorption isotherm was found to be nearly identical to the first sorption isotherm, indicating that repetitive isotherms on the same sample at different temperatures does not alter the structure of the material. There is a large hysteresis at higher humidity which is not present at lower humidities, demonstrating that the process of switching between a non-porous phase and a porous phase is completely reversible.

Kinetic Studies of sql-2-Cu—BF₄

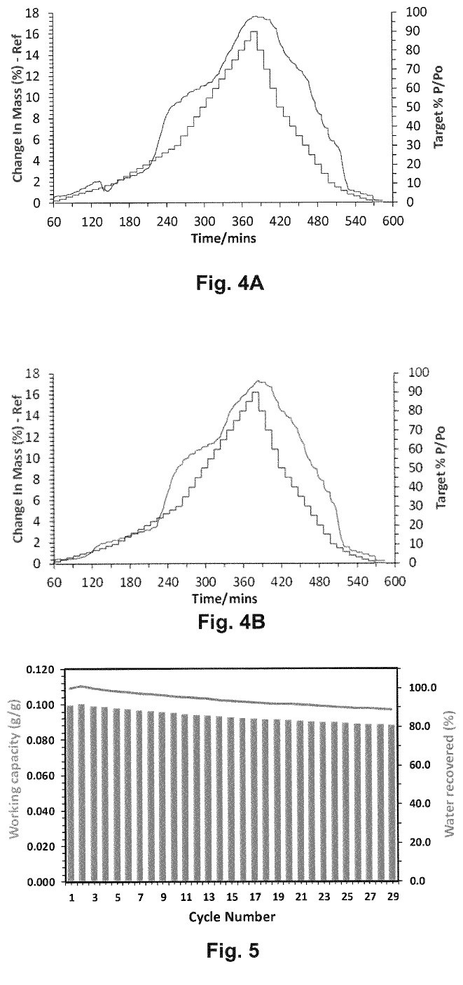

Water sorption kinetic data was collected for sql-2-Cu—BF₄ at 25° C. and 35° C., shown in FIG. 4A and FIG. 4B respectively. The adsorption and desorption mechanism profiles are similar at 25° C. and 35° C., with a total uptake of 18 wt % observed. The sample adsorbed water molecules in small increments, with considerably fast adsorption and desorption kinetics.

Reversibility Studies of sql-2-Cu—BF₄

Reversibility tests on sql-2-Cu—BF₄ were performed at 25° C. to calculate the working capacity in g/g and are shown in FIG. 5.

### EXAMPLE 2: sql-3-Cu—BF₄

Synthesis of sql-3-Cu—BF₄

Cu(BF₄).6H₂O (0.237 g, 1 mmol), 1,4-bis(4-pyridyl)biphenyl (0.616 g, 2 mmol) and a few drops of methanol were grinded together for 30 minutes using a ball mill with a frequency of 25 Hz. The resulting powder was washed three times with methanol.

Water Vapour Sorption Studies of sql-3-Cu—BF₄

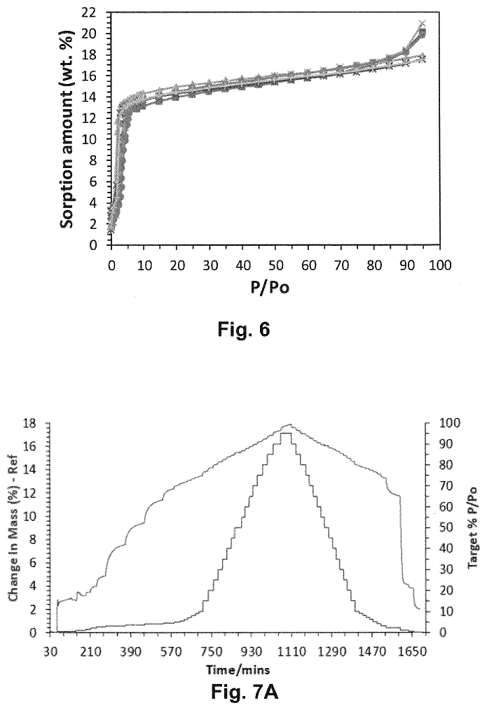

Water sorption isotherms for sql-3-Cu—BF₄ were collected at 25° C., 30° C. and 35° C., shown in FIG. 6. The hysteresis gap for this material is narrow, which indicates that water desorption is not restricted. Below 80% relative humidity, water uptake remains unchanged and is independent of temperature, while above 80% relative humidity the water uptake is lower at 35° C. compared to 25° C. and 30° C. The lower water uptakes at higher temperature are expected for a surface adsorption mechanism. All isotherms show type F-IV behaviour, which indicates a sudden switching from a closed phase to an open phase.

The heat of sorption was calculated from the linear region of the isotherms collected for sql-3-Cu—BF₄ at 25° C., 30° C. and 35° C. using a Virial model. The average heat of sorption for sql-3-Cu—BF₄ was found to be lower than the heat of vaporisation for water at 25° C. This demonstrates the intrinsic heat management offered by square lattice networks, reducing the amount of heat released during adsorption and the impact of cooling during desorption.

Kinetic Studies of sql-3-Cu—BF₄

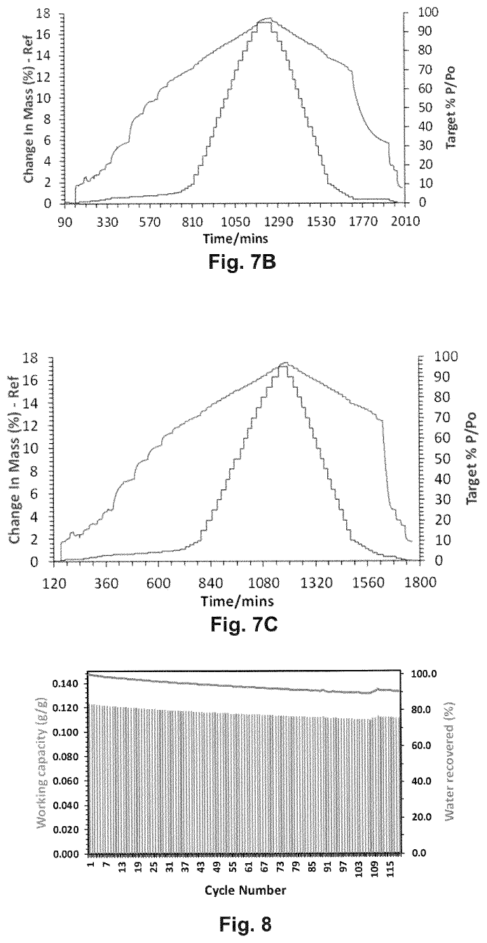

Water sorption kinetic data was collected for sql-3-Cu—BF₄ at 25° C., 30° C. and 35° C. over a 0% to 95% relative humidity range, demonstrated in FIGS. 7A, 7B and 7C, respectively. Some water (approximately 10%) is found to remain in the material when desorption steps have completed, illustrated by the mass not returning to its original value at 0% relative humidity. Therefore the structure requires heating or high vacuum in order for the water to be completely removed.

Reversibility Studies of sql-3-Cu—BF₄

sql-3-Cu—BF₄ was subjected to a 0% to 10% to 0% relative humidity sequence 119 times, and all isotherms were taken on the same sample. Reversible switching isotherms are observed, showing that this material has a robust flexible structure and behaves predictably.

sql-3-Cu—BF₄ shows a high working capacity in the low partial pressure range as demonstrated in FIG. 8, making sql-3-Cu—BF₄ a potential candidate for water capture in arid conditions.

### EXAMPLE 3: sql-1-Co—NO₃

Synthesis of sql-1-Co—NO₃

sql-1-Co-NO₃ was prepared by solvent diffusion. A mixture of 2.5 ml methanol and 2.5 ml α,α,α-trifluorotoluene (TFT) was slowly layered over 4,4′-bipyridine (0.3 mmol, 46.8 mg) dissolved in 5 ml of TFT. A solution of Co(NO₃)₂.6H₂O (0.3 mmol, 87.3 mg) in 5 ml methanol was layered over the methanol/TFT layer. The red brick crystals were collected by filtration and washed with TFT three times.

Structure of sql-1-Co—NO₃

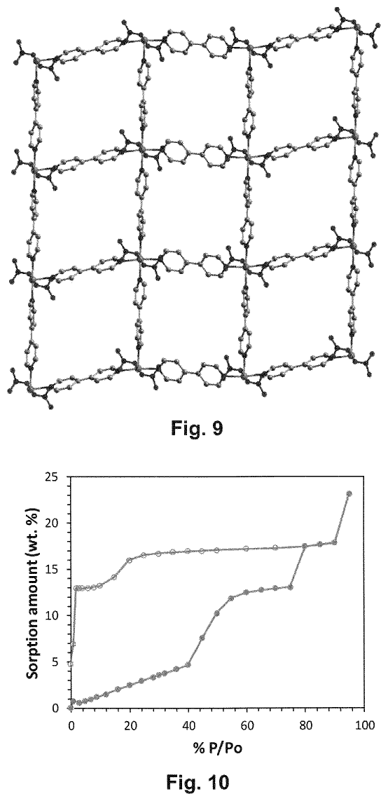

sql-2-Co—NO₃ forms a two-dimensional layered network with Co²⁺ ions connected in one and two dimensions by 4,4′-bipyridine to form a square lattice, with NO₃⁻ also coordinated at the axial positions. The structure can be seen in FIG. 9. This material has an effective pore size of approximately 7.5 Å×7.5 Å.

Water Vapour Sorption Studies of sql-1-Co—NO₃

Water sorption isotherms were collected on sql-1-Co—NO₃ at 25° C., shown in FIG. 10. The isotherm demonstrates mixed Type F-I and Type F-II behaviour, indicated by a low initial adsorption and substantial uptake at higher relative humidity. The isotherm also shows that the material switches from an open phase to a more open phase.

The sample retains approximately 4.7% water vapour mass at 0% relative humidity, resulting in an open hysteresis loop. This indicates the sql-1-Co—NO₃ requires heating or high vacuum in order to fully vacate the structure at low partial pressures.

Kinetic Studies of sql-1-Co—NO₃

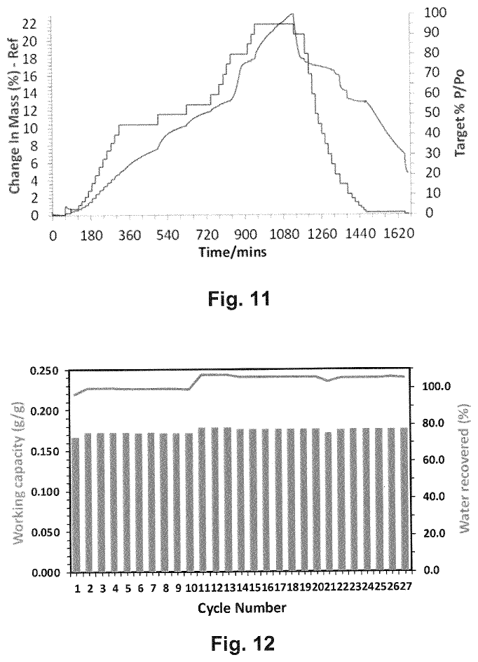

Water sorption and desorption kinetics for sql-1-Co—NO₃ were studied at 25° C. and summarised in FIG. 11.

Reversibility Studies of sql-1-Co—NO₃

There is no discernible difference between the first and tenth cycle isotherms, as illustrated by FIG. 12. In addition, there is no hysteresis between the sorption and desorption isotherms. This indicates that the water sorption mechanism is completely reversible after slight heating at 40° C. between each cycle, and there are no sample history effects related to water sorption. In total, 27 complete adsorption and desorption cycles were collected and the working capacity is also almost constant across the cycles.

### EXAMPLE 4: sql-1-Ni—NO₃

Synthesis of sql-1-Ni—NO₃

sql-1-Ni—NO₃ was also prepared using solvent diffusion. A mixture of 2.5 ml methanol and 2.5 ml α,α,α-trifluorotoluene (TFT) was slowly layered over 4,4′-bipyridine (0.3 mmol, 46.8 mg) dissolved in 5 ml of TFT. A solution of Ni(NO₃)₂.6H₂O (0.3 mmol, 87.3 mg) in 5 ml methanol was layered over the methanol/TFT layer. The blue crystals were collected by filtration and washed with TFT three times.

Structure of sql-1-Ni—NO₃

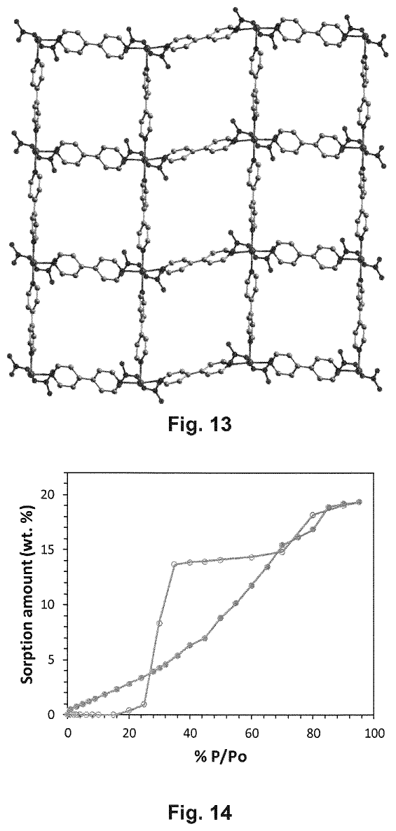

sql-1-Ni—NO₃ forms a two-dimensional layered network with Ni²⁺ ions connected in one and two dimensions by 4,4′-bipyridine to form a square lattice, with NO₃⁻ also coordinated at the axial positions. The structure can be seen in FIG. 13. This material has an effective pore size of approximately 7.5 Å×7.5 Å.

Water Vapour Sorption Studies of sql-1-Ni—NO₃

Water sorption isotherms were collected on sql-1-Ni—NO₃ at 25° C., shown in FIG. 14. This material has a broad hysteresis in the region between 30% and 70% relative humidity and the loss of water is dramatic during the desorption isotherm, indicating an imminent closed phase structure during dehydration. The isotherm can be characterised by a Type F-III isotherm that shows a gradual uptake from low to high partial pressure.

Kinetic Studies of sql-1-Ni—NO₃

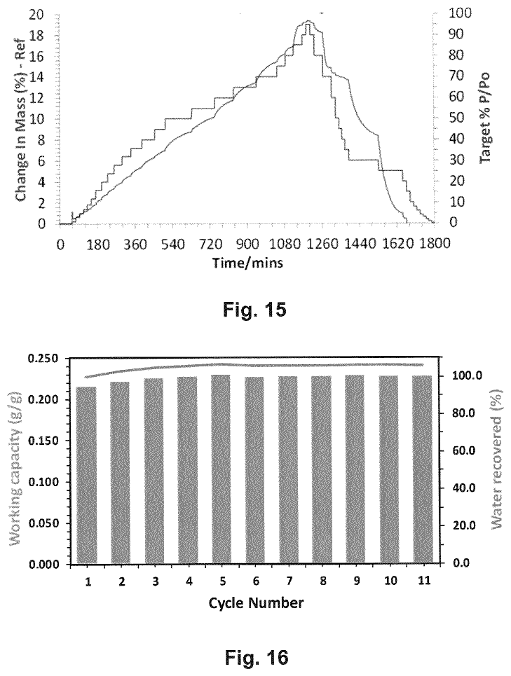

Water sorption and desorption kinetics for sql-1-Ni—NO₃ were studied at 25° C. and are summarised in FIG. 15.

Reversibility Studies of sql-1-Ni—NO₃

Reversibility tests on sql-1-Ni—NO₃ were performed to calculate the working capacity and are shown in FIG. 16.

### EXAMPLE 5: scl-1-Cu—NO₃

Synthesis of sql-1-Cu—NO₃

sql-1-Cu—NO₃ was again prepared by solvent diffusion, in a similar fashion to sql-1-Ni—NO₃ and sql-1-Co-NO₃. A mixture of 2.5 ml methanol and 2.5 ml α,α,α-trifluorotoluene (TFT) was slowly layered over 4,4′-bipyridine (0.3 mmol, 46.8 mg) dissolved in 5 ml of TFT. A solution of Cu(NO₃)₂.6H₂O (0.3 mmol, 87.3 mg) in 5 ml methanol was layered over the methanol/TFT layer. The dark blue crystals were collected by filtration and washed with TFT three times.

Structure of sql-1-Cu—NO₃

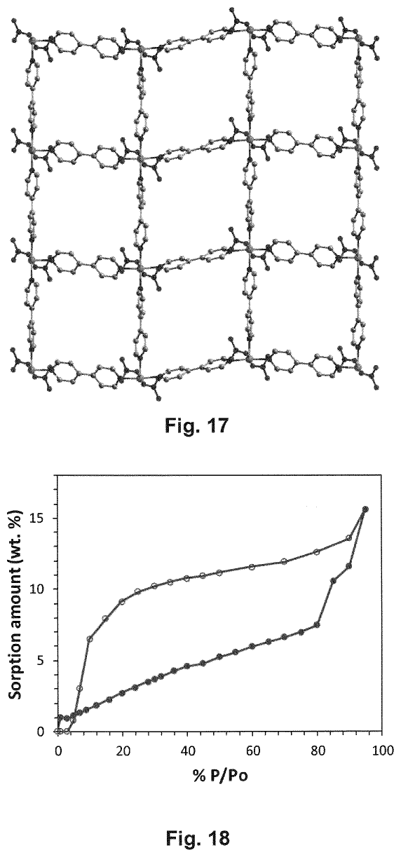

sql-1-Cu—NO₃ forms a two-dimensional layered network with Cu²⁺ ions connected in one and two dimensions by 4,4′-bipyridine to form a square lattice, with NO₃⁻ also coordinated at the axial positions. The structure can be seen in FIG. 17. This material has an effective pore size of approximately 7.5 Å×7.5 Å.

Water Vapour Sorption Studies of sql-1-Cu—NO₃

Water sorption isotherms were collected on sql-1-Cu—NO₃ at 25° C. and are shown in FIG. 18. The sample progressively adsorbs water until 80% relative humidity, where a significant mass uptake is observed. During desorption, the sample loses a large amount of water, returning to the sorption 0% level at 3% relative humidity. This indicates that the sample returns to the initial form. This material can be characterised by a Type F-III isotherm, showing a gradual uptake from low or intermediate partial pressures and a high uptake at elevated partial pressure. In addition, the hysteresis gap presents shape memory.

Kinetic Studies of sql-1-Cu—NO₃

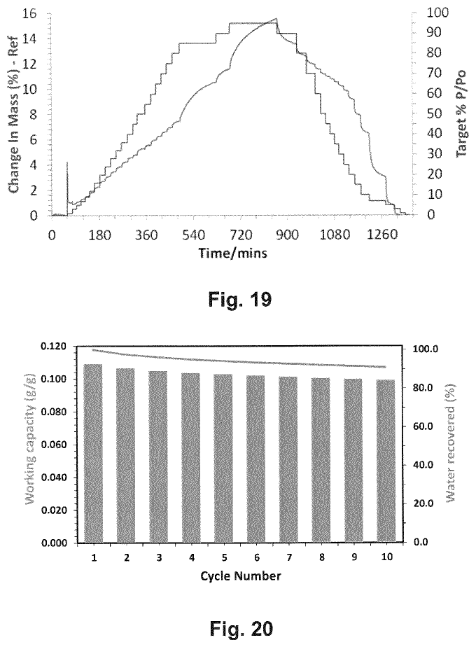

Water vapour sorption kinetics for sql-1-Cu—NO₃ were collected at 25° C. and are shown in FIG. 19. The sample mass increases progressively, achieving a 16% change in mass.

Reversibility Studies of sql-1-Cu—NO₃

Reversibility tests on sql-1-Cu—NO₃ were conducted at 25° C. for ten adsorption-desorption cycles and are summarised in FIG. 20.

### EXAMPLE 6: sql-2-Cu-OTf

Synthesis of sql-2-Cu-OTf

An ethanol solution (3 ml) containing 1,4-bis(4-pyridyl)benzene (11.6 mg, 0.05 mmol) was slowly layered on top of an aqueous solution (3 ml) copper triflate (9 mg, 0.025 mmol). The light purple crystals were collected by filtration.

Structure of sql-2-Cu-OTf

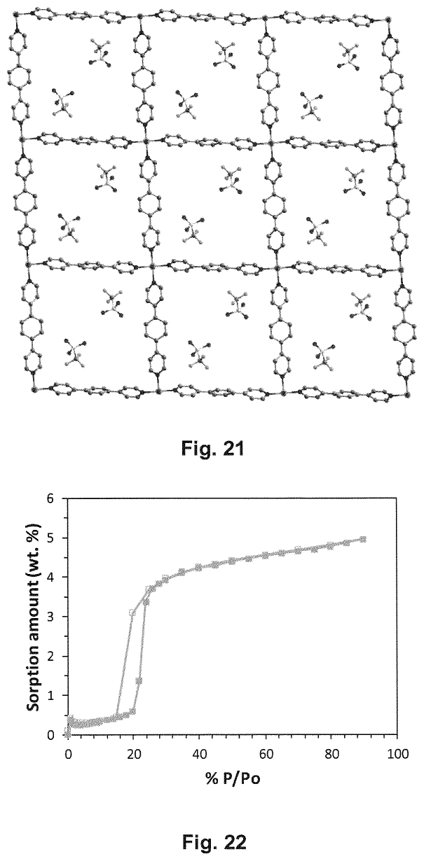

sql-2-Cu-OTf forms a two-dimensional layered network with Cu²⁺ ions connected in one and two dimensions by 1,4-bis(4-pyridyl)benzene to form a square lattice shown in FIG. 21. There are ethanol and water molecules present in the lattice, as well as one coordinated water molecule. The square lattice frameworks are stacked above each other with an interlayer separation of 4.634 Å. The guest accessible volume was found to be 20%.

Water Vapour Sorption Studies of sql-2-Cu-OTf

The water vapour sorption isotherm for sql-2-Cu-OTf was collected at 25° C. and is shown in FIG. 22. Below 18% relative humidity, the material almost behaves as a non-porous material, demonstrating little water adsorption. The isotherm shows a dramatic increase in mass between 18% and 30% relative humidity, giving rise to the theory of a closed phase at 0% relative humidity with the ability to reach an open phase at 20% relative humidity. This isotherm closely resembles the Type F-II isotherm with a mild hysteresis gap between 15% and 25% partial pressure.

Kinetic Studies of sql-2-Cu-OTf

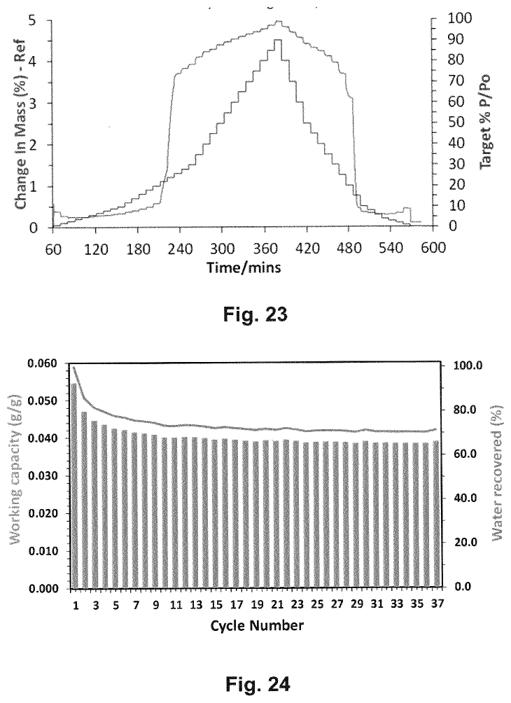

Water sorption and desorption kinetics for sql-2-Cu-OTf were obtained at 25° C. The kinetic data in FIG. 23 demonstrates that all steps reach equilibrium.

Reversibility Studies of sql-2-Cu-OTf

sql-2-Cu-OTf was subjected to a 0% to 30% to 0% relative humidity sequence 37 times, with isotherms collected on the same sample. Following 37 cycles, sql-2-Cu-OTf is able to uptake 71% of the initial water uptake compared to the first cycle. There is no significant change in the measured water content after the first seven cycles. This demonstrates that sql-2-Cu-OTf is able to reversibly transform its structural framework from a closed phase to an open phase. The results are summarised in FIG. 24.

### EXAMPLE 7: sql-A14-Cu—NO₃

Synthesis of sql-A14-Cu—NO₃

A buffer of isopropanol and water (2 ml, v/v=1:1) was layered over an aqueous solution of Cu(NO₃).3H₂O (3 mg, 0.012 mmol). An isopropanol solution of 4,4′-(2,5-dimethyl-1,4-phenylene)dipyridine (7.8 mg, 0.03 mmol) was layered over the buffer layer at room temperature. The resulting blue crystals were isolated with a calculated yield of 55%.

Structure of sql-A14-Cu—NO₃

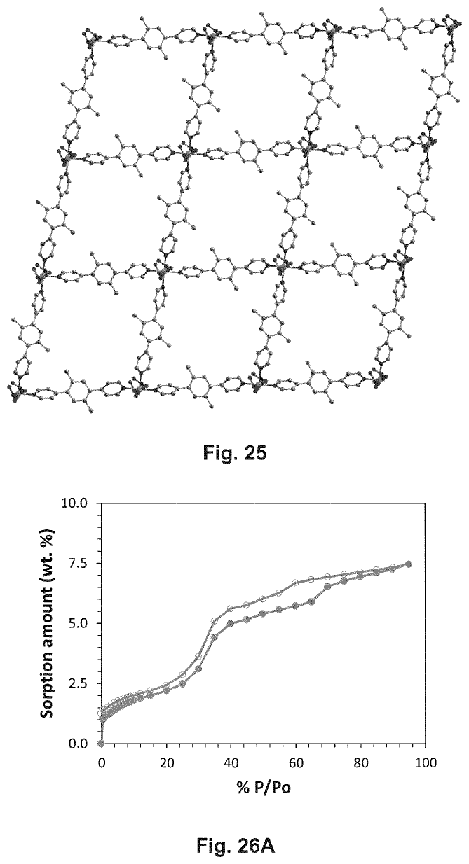

sql-2-Cu-OTf forms a two-dimensional layered network with Cu²⁺ ions connected in one and two dimensions by 4,4′-(2,5-dimethyl-1,4-phenylene)dipyridine to form a square lattice shown in FIG. 25. Terminal NO₃⁻ ions are also coordinated at the axial positions. The guest accessible volume was found to be 17%.

Water Vapour Sorption Studies of sql-A14-Cu—NO₃

Water vapour sorption studies for sql-A14-Cu—NO₃ were performed at 25° C. and 30° C., shown in FIGS. 26A and 26B, respectively. The sample has a narrow hysteresis in the region between 15% and 80% relative humidity. FIG. 26A suggests an adsorption mechanism dominated by Type F-I behaviour, illustrating a gradual mechanism from an open phase to a more open phase.

Kinetic Studies of sql-A14-Cu—NO₃

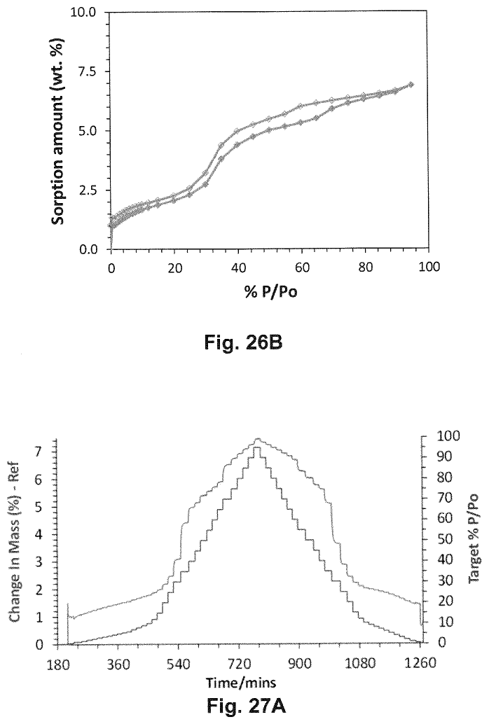

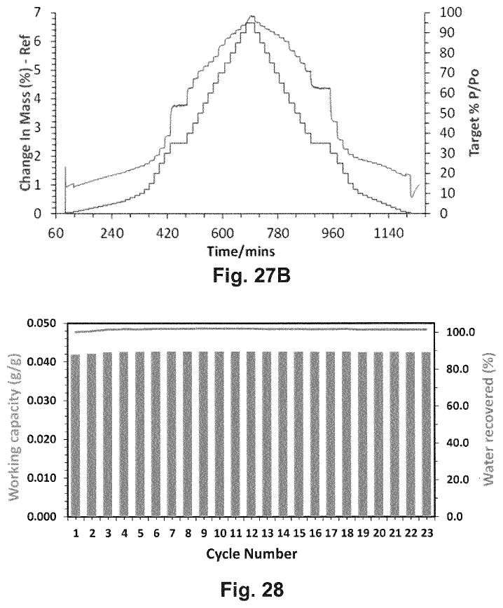

Water sorption and desorption kinetics for sql-A14-Cu—NO₃ were obtained at 25° C. and 30° C. The kinetic data is summarised in FIGS. 27A and 27B for 25° C. and 30° C., respectively.

Reversibility Studies of sql-A14-Cu—NO₃

Twenty-three cycles of adsorption and desorption at 25° C. were performed in total. The adsorption and desorption branch show good agreement, suggest no significant hysteresis. As demonstrated in FIG. 28, the material retains constant working capacity across all of the cycles. The material sql-A14-Cu—NO₃ has a high stability against repeated relative humidity cycles.

### EXAMPLE 8: [Cu₂(glutarate)₂(4,4′-bipyridine)]

Synthesis of [Cu₂(glutarate)₂(4,4′-bipyridine)]

Cu(NO₃).3H₂O (242 mg, 1 mmol), glutaric acid (132.1 mg, 1 mmol), and 4,4′-bipyridine (78 mg, 0.5 mmol) were mixed in water (100 ml). NaOH was added dropwise with swirling to the solution to prevent precipitation. The blue solution was placed in an oven preheated to 85° C. Green powder was obtained after 24 to 48 hours. This compound may also be referred to as ROS037. FIGS. 29A and 29B shows the crystallographic structure of this compound.

Water Vapour Sorption Studies of [Cu₂(glutarate)₂(4,4′-bipyridine)]

Water vapour sorption studies for [Cu₂(glutarate)₂(4,4′-bipyridine)] were performed at 25° C., shown in FIG. 30. The sample shows a very narrow hysteresis gap, indicating that water desorption is not restricted.

Kinetic Studies of [Cu₂(glutarate)₂(4,4′-bipyridine)]

Water sorption and desorption kinetics for [Cu₂(glutarate)₂(4,4′-bipyridine)] were obtained at 25° C., demonstrated in FIG. 31. The kinetics data in FIG. 31 show that all steps reach equilibrium over a range of temperatures. The removal of water from the structure does not require any additional heating or vacuum, as evidenced by the mass returning to its original value at 0% relative humidity.

Reversibility Studies of [Cu₂(glutarate)₂(4,4′-bipyridine)]

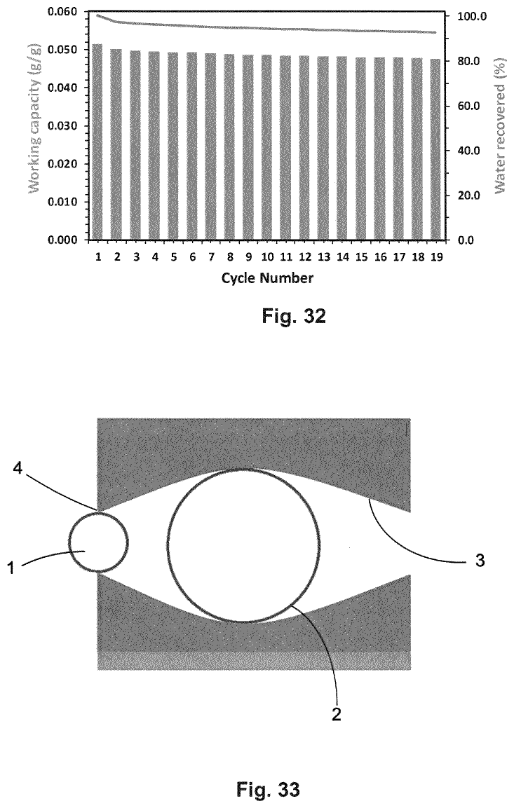

Nineteen cycles of adsorption and desorption at 25° C. were performed in total. Reversible switching isotherms are observed and no hysteresis gap is detected, indicating water desorption is not restricted. [Cu₂(glutarate)₂(4,4′-bipyridine)] shows a high working adsorption capacity in the low partial pressure range (≤30% P/Po), as demonstrated in FIG. 32.

### EXAMPLE 9: Alternative Synthesis of [Cu₂(glutarate)₂(4,4′-bipyridine)]

In a beaker, Cu(OH)₂ (488 mg, 5 mmol) was suspended in 100 mL of water with stirring for 5 minutes. Glutaric acid (1.32 g, 10 mmol) was added and allowed to stir for 5 minutes. The solution became clear and dark blue in colour. 4,4′-bypyridyl (390.5 mg, 2.5 mmol) was added and a green precipitate was formed in 10 minutes. The mixture was filtered and washed with 50 mL of water to obtain the solid product, Yield, 1.332 g, >94%.

Characterisation of the product confirmed this to be identical to the product obtained in Example 8.

### EXAMPLE 10: Lab-Scale Synthesis of [Cu₂(glutarate)₂(4,4′-bipyridine)]

ROS-037 was synthesized in lab scale by a modified literature protocol as follows: 350 mL of water was taken in a 500 mL conical flask and glutaric acid (24.3 g, 0.184 mol) was added followed by the addition of NaOH (14.7 g, 0.368 mol) and stirred until a clear solution was obtained. Cu(NO₃)₂.2.5H₂O (42.7 g, 0.184 mol) was added and allowed to stir for 10 minutes. 4,4′-bypyridyl (14.4 g, 0.092 mol) was added and the mixture was allowed to stir for 1 hour at 70° C. Once the reaction was completed, the solution was filtered to obtain the solid product, and further washed with water to remove any traces of unreacted reactants and air dried. Yield, ˜48 g, >98%.

Characterisation of the product confirmed this to be identical to the product obtained in Example 8.

### EXAMPLE 11: Scale-Up Synthesis of [Cu₂(glutarate)₂(4,4′-bipyridine)]

ROS-037 can be scaled up to mini-plant scale by water slurry method as follows. 3.5 L of water was added to the 5 L reactor and the stirrer was set to 750 rpm. Glutaric acid (243 g, 1.84 mol) was added and allowed to dissolve for 10 minutes. NaOH (147 g, 3.68 mol) was added and the temperature of the reactor was set to 70° C. (Note: Reaction can be carried out at room temperature also, however more reaction time is required). Once a clear solution is obtained, Cu(NO₃)₂.2.5H₂O (427 g, 1.84 mol) was added and allowed to stir for 15 minutes. 4,4′-bypyridyl (144 g, 0.92 mol) was added and the mixture was allowed to stir for 6 hours. Once the reaction was complete, the solution was filtered to obtain the solid product, which was further washed to remove any traces of NaOH and unreacted reactants and air dried. Yield, 481 g, >98%.

Characterisation of the product confirmed this to be identical to the product obtained in Example 8.

### EXAMPLE 12: Synthesis of [Co₃(μ₃-OH)₂(btca)₂]

A mixture of benzotriazole-5-carboxylic acid (H₂btca; 0.3 mmol, 48 mg), Co(NO₃)₂.6H₂O (0.5 mmol, 145 mg), CH₃CN (3 mL), and H₂O (2 mL) was sealed in a 15-mL Teflon-lined stainless reactor, which was heated to 150° C. and held at that temperature for 5 days. After cooling to room temperature, red-pink crystals were separated by decanting and washed with water. Yield: 28 mg, 31%.

The composition of the material was confirmed by PXRD.

The vapour sorption isotherm for this material is shown in FIG. 36.

### EXAMPLE 13: Synthesis of [Mg₃(μ₃-OH)₂(2,4-pyridinedicarboxylate)₂]

Pale yellow solution of 2,4-pyridinedicarboxylic acid (167 mg, 1 mmol) and 2 mL of 2M KOH (4 mmol) in 2 mL of H₂O was prepared. Mg(NO₃)₂.6H₂O (384 mg, 1.5 mmol) was dissolved in 3 mL of H₂O in a Teflon lined steel autoclave (˜23 mL). The solution of 2,4-pyridinedicarboxylic acid was added to a solution of Mg(NO₃)₂ 6H₂O under stirring, the formation of white suspension was observed. The reactor was sealed and heated at 210° C. for 15 hours. After cooling over 6 hours, the white crystals were filtered off and washed with water. The solid was then dried in air at ambient conditions. Yield: 130-180 mg, 43-60%.

The composition of the material was confirmed by PXRD.

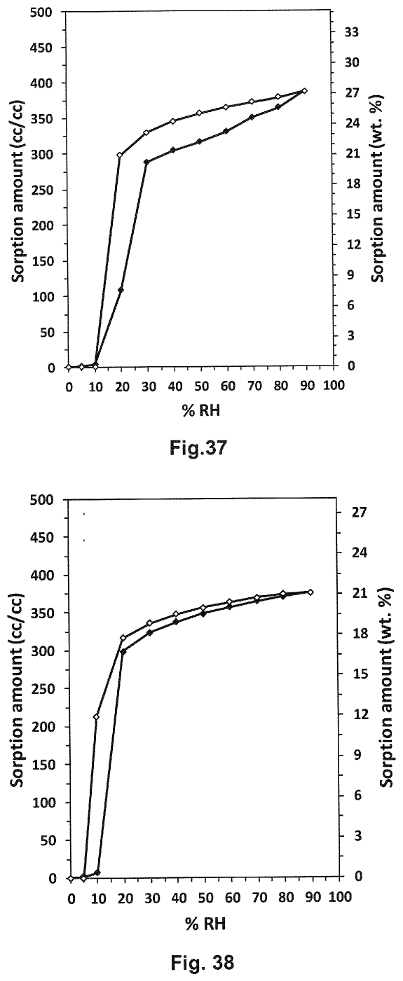

The vapour sorption isotherm for this material is shown in FIG. 37.

### EXAMPLE 14: Synthesis of [Co₃(μ₃OH)₂(2,4-pyridinedicarboxylate)₂]

A solution of 2,4-pyridinedicarboxylic acid (185 mg, 1.0 mmol) and KOH (1.0 M, 3.0 mL) in H₂O (3.0 mL) was added to a stirred aqueous solution (4.0 mL) of CoCl₂.6H₂O (357 mg, 1.5 mmol). The resulting viscous, opaque mixture was heated to 200° C. in a Teflon-lined steel autoclave over 15 h, and then cooled to room temperature over 6 h. The crystalline solid was purified by cycles (3×30 min) of ultrasonic treatment in H₂O (20 mL), followed by decanting of the cloudy supernatant. The solid was then dried in air at ambient conditions. Yield: 210 mg (46%).

The vapour sorption isotherm for this material is shown in FIG. 38.

### EXAMPLE 15: Synthesis of [(Cu₂(glutarate)₂(1,2-di(pyridine-4-yl)-ethene)]

Glutaric acid (198.0 mg, 1.5 mmol) was dissolved in 10 mL of water in a glass bottle. The solution was heated to 70° C. on a hot plate while stirring. NaOH (120 mg, 3 mmol) was dissolved in 5 mL of water and was slowly added to the hot solution of glutaric acid. Cu(NO₃)₂.3H₂O (241.6 mg, 1 mmol) was dissolved in 5 mL of water and added to the hot reaction mixture. A light blue precipitate was formed. After letting the reaction to stir for 10 min, 1,2-di(pyridine-4-yl)-ethene (91.1 mg, 0.5 mmol) was added to the reaction mixture. The precipitate turned to a rich green colour. The reaction mixture was left stirring for 24 h at 80° C. After cooling, the precipitate was filtered, washed with water and oven-dried at 85° C. This material may also be known as AMK-059.

The composition of the material was confirmed by PXRD.

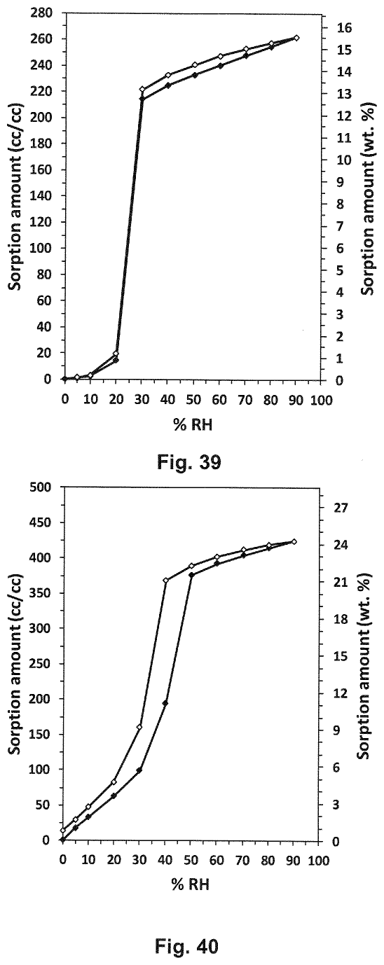

The vapour sorption isotherm for this material is shown in FIG. 39.

### EXAMPLE 16: Synthesis of [Zr₁₂O₈(μ₃-OH)₈(μ₂-OH)₆(benzene-1,4-dicarboxylate)₉]

In a Teflon lined steel autoclave (23 mL), ZrOCl₂ 8H₂O (97 mg, 0.3 mmol), H₂O (2 mL) and acetic acid (3 mL) were added and formation of clear solution was observed. Terephthalic acid (50 mg, 0.3 mmol) was added to the reaction mixture. The reaction mixture was heated at 150° C. for 1 day. After cooling, the white precipitate was filtered off and washed with H₂O (yield 90 mg), soaked once with 9 mL DMF and soaked three times with H₂O. The solid was then dried in air at ambient conditions.

The composition of the material was confirmed by PXRD.

The vapour sorption isotherm for this material is shown in FIG. 40.

### EXAMPLE 17: Loading of [(Cu₂(glutarate)₂(4,4′-bipyridine)] (ROS-037) on a Polymer Support

In a beaker, binder (Acrylic Polymer: HYCAR® 26410 from Lubrizol) was taken and water was added, stirred for 5 minutes. Isopropanol was added and the mixture stirred for a further 5 more and, while stirring continuously, [Cu₂(glutarate)₂(4,4′-bipyridine)] in powder form was added slowly to the solution. The stir bar was removed and blended for 1 minute using a hand blender with short bursts at high speed. Approximately 2 mL of slurry was taken from the beaker by using a dropper and drop casted onto a Teflon petridish before being placed in an oven for 1 hour at 120° C. and transferred to desiccator. The resulting thin film type was tested for its water sorption properties.

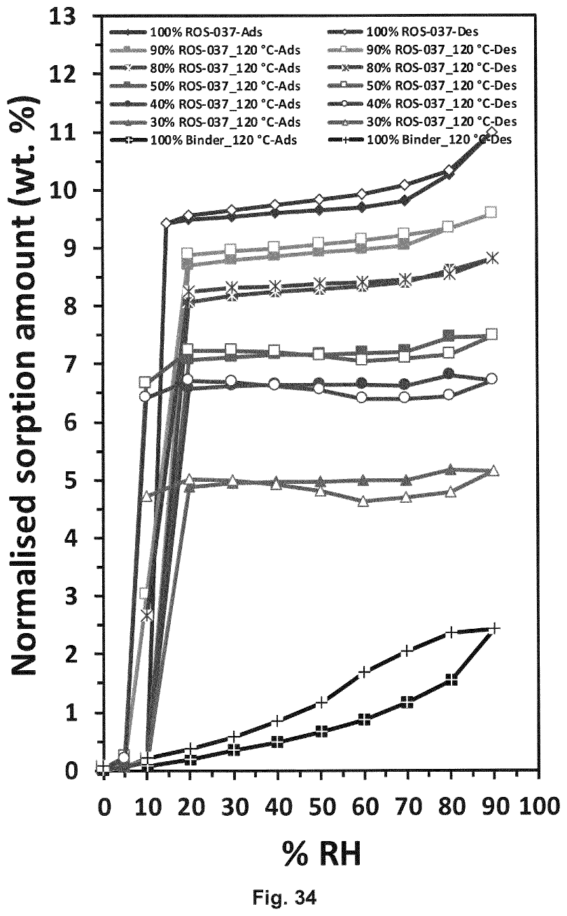

Films were prepared comprising 0, 30, 40, 50, 80, 90 and 100% ROS-037. Adsorption and desorption isotherms were measured at 27° C. and these are shown in FIG. 34. The top curve is for the composition comprising 100% ROS-037 and the bottom one is for the composition comprising 100% binder.

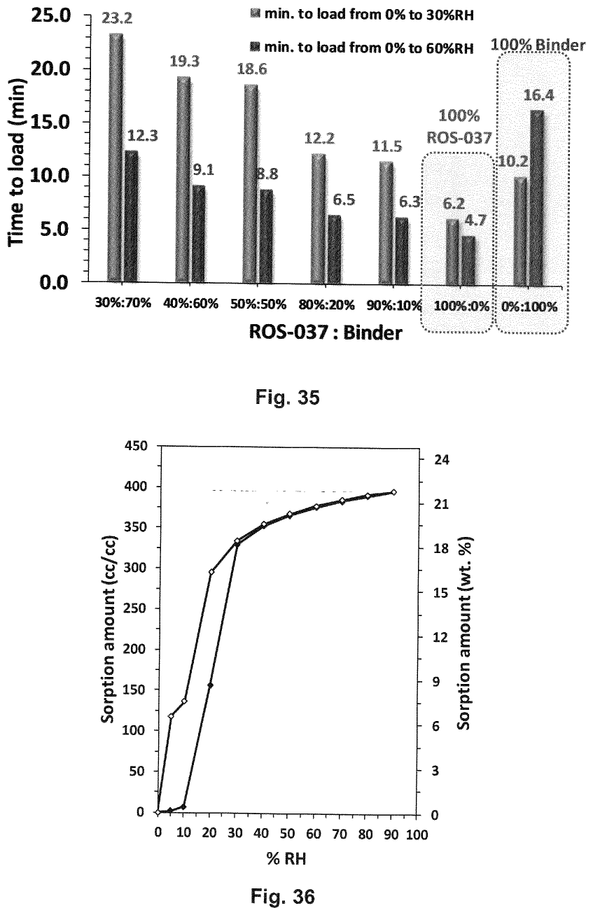

FIG. 35 shows the kinetics of adsorption.

These results show that the greater the amount of [Cu₂(glutarate)₂(4,4′-bipyridine)] present in the composite, the faster the kinetics of adsorption and the higher the water uptake.

### EXAMPLE 18: Loading of [(Cu₂(glutarate)₂(4,4′-bipyridine)] (ROS-037) on a Paper Support

[Cu₂(glutarate)₂(4,4′-bipyridine)] powder was added in a standard cellulose paper making process that anyone skilled in the art could perform. Cellulose fiber was first dispersed in water at approximately 3-5% solids. [Cu₂(glutarate)₂(4,4′-bipyridine)] powder was added to the fiber mixture and agitated in order to disperse. The blend was then diluted to very low solids content (1% or less) to provide an attraction between the fibers and the desiccant powder. The evenly dispersed mixture was drained through a screen. The remaining water was removed from the wet sheet of fibers/powder through vacuum, pressing, and drying. Good adsorption and desorption properties were recorded for the resulting material.

FIG. 41 shows the Powder X-ray diffraction spectrum of the paper composite (top line) in comparison with as synthesized powder (middle line) and calculated powder (bottom line).

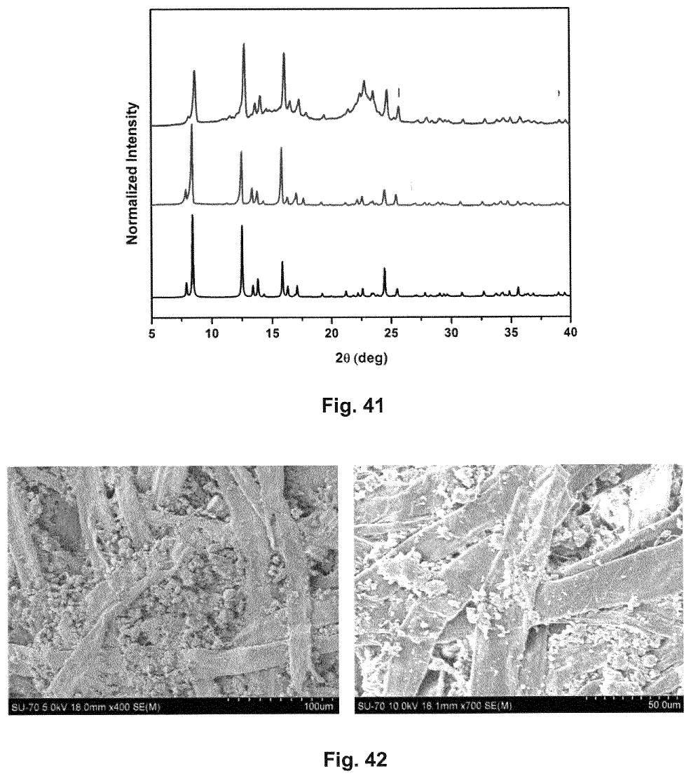

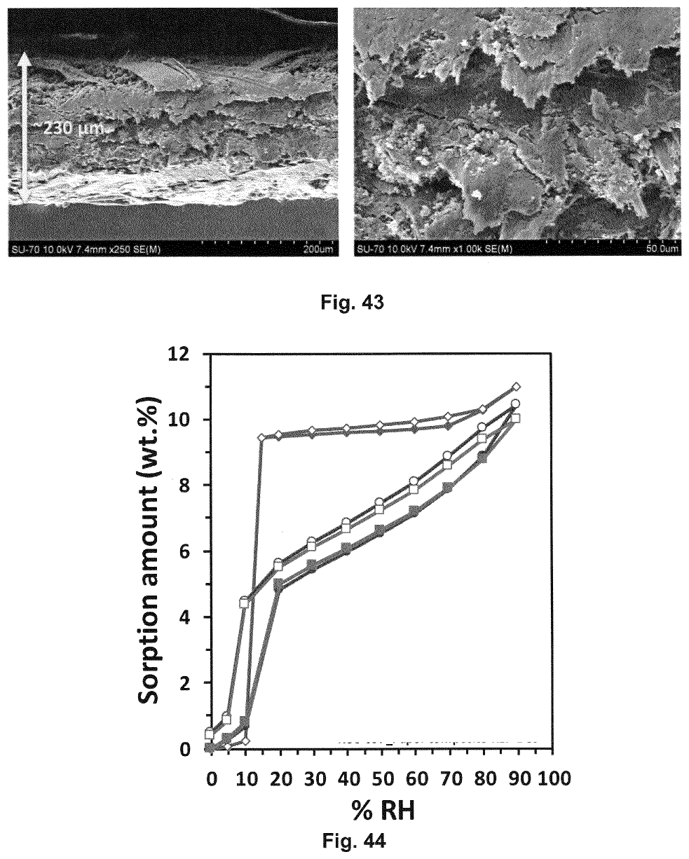

FIGS. 42 and 43 show respectively flat section and cross section SEM images of the paper composite.

FIG. 44 shows experimental isotherms for water vapour sorption at 27° C. on [Cu₂(glutarate)₂(4,4′-bipyridine)] powder and its paper composite, respectively from the top down. In-situ pre-treatment (intrinsic-DVS) before collecting isotherm at 40° C. for 120 min. Isotherm collected at 27° C. (Intrinsic-DVS). dm/dt<0.01%/min.

### EXAMPLE 19: Desalination Testing Using [(Cu₂(glutarate)₂(4,4′-bipyridine)]

[Cu₂(glutarate)₂(4,4′-bipyridine)] samples were placed in an oven for 12 h at 80° C. Afterwards, the container was sealed and kept under nitrogen flow for 2 h. Adsorbent-solution (solution of 30 mL of saline (NaCl) aqueous solution in a concentration range from 0.0 to 111.1 g/L exposed to 1 g/L, 50 g/L or 500 g/L of adsorbent) were studied at 25° C. Suspensions were stirred using a magnetic stirrer for 8 h. The resulting slurry was filtered with a syringe filter (0.22 μm pore size) and the residual saline solution was collected. NaCl concentration in all aqueous solution (before and after soaking [Cu₂(glutarate)₂(4,4′-bipyridine)] at different concentrations) was analysed by using a conductivity meter (model: JENWAY 4510). Measurements were performed three times and the mean was calculated. The concentration of NaCl (g/L) was determined by correlating the conductivity (mS) and a [NaCl] calibration curve. The results indicate that [Cu₂(glutarate)₂(4,4′-bipyridine)] increased NaCl concentration by the expected amount in every experiment.

### CHARACTERISATION EXAMPLES

The porous metal-organic framework materials useful in the present invention have a number of common characteristics and the properties of these materials were tested according to the following methods.

The properties of the porous metal-organic framework materials of the invention were also compared to silica and mesoporous silica. These materials are the current commercially available materials which can be used in the same applications as the inventive materials.

Metal-organic materials useful in the present invention preferably satisfy the following criteria:

1. Favourable kinetics of adsorption: materials that reach greater than 80% of full loading in less than 10 minutes at 27° C. and 30% RH are preferred.

2. Water sorption capacity: materials that offer a water sorption capacity of cm³ water vapour/cm³ material under ambient conditions of temperature and humidity (27° C., 1 atm) as determined by vacuum, temperature, humidity or temperature/humidity swing tests are preferred.
2.1. Vacuum swing tests were conducted using materials that were first fully loaded with water at 97% RH and ambient pressure and subjected to 3 torr of vacuum for 15 minutes.
2.2. Temperature swing tests were conducted by first loading materials at 27° C. and 30% RH for 14 minutes followed by heating at 60° C. for 15 minutes.
2.3. Humidity swing tests were conducted by first loading activated sorbents at 30% RH at 27° C. for 14 minutes followed by exposure to a 0% humidity dry gas stream for 40 minutes.
2.4. Temperature and humidity swing tests that simulate direct air water capture in desert conditions were conducted through 17 adsorption/desorption cycles which involved loading the sorbent at 30% RH at 25° C. for 14 minutes and unloading the sorbent by heating at 49° C. for 20 minutes.

3. Thermodynamics of desorption tests were conducted by first loading the porous material at ambient conditions and ˜30-40% RH. Sorbents that offer a desorption temperature <75° C. (determined by the position of the water desorption endotherm minimum when collected using differential scanning calorimetry (DSC)), and a heat of desorption <50 kJ/mol (as measured by combining thermogravimetric analysis (TGA), DSC and intrinsic Dynamic Vapour Sorption isotherm (DVS) measurements) are preferred.

### EXAMPLE 20: Sorption Kinetics Testing

Intrinsic dynamic vapour sorption measurements were carried out on a number of materials at 27° C. and 30% relative humidity. The level of uptake capacity achieved after 10 minutes is shown in Table 1:

TABLE 1
Uptake Capacity

| Metal-organic material | % Water loading after 10 minutes |
|---|---|
| ROS-037 (Example 8) | 99.9 |
| ROS-037 Paper Composite (Example 18) | 82.4 |
| Silica Gel | 74.6 |

### EXAMPLE 21: Working Capacity

The working capacity is the difference in water vapour uptake between conditions of adsorption and desorption.

Adsorption/desorption was induced in various materials under conditions of a vacuum swing, a temperature swing or a humidity swing (see 2.1, 2.2 and 2.3 above for conditions). The results are shown in Tables 2, 3 and 4.

Following the procedure of section 2.1, a 3 torr vacuum was used and the working capacity was recorded after 15 minutes, as shown below in Table 2:

TABLE 2
Vacuum Swing Testing

| | Working capacity |
|---|---|
| Metal-organic material | (cm³ water vapour/cm³ material) |
| sql-2-Cu-BF₄ (Example 1) | 306.8 |
| AMK-059 (Example 15) | 200.8 |
| ROS-037 (Example 8) | 150.8 |
| Mesoporous Silica | 39.9 |
| Silica Gel | 36.4 |

Following the procedure of section 2.2, the working capacity was recorded after 15 minutes, as shown below in Table 3:

TABLE 3
Temperature Swing Testing

| | Working capacity |
|---|---|
| Metal-organic material | (cm³ water vapour/cm³ material) |
| Co-CUK-1 (Example 14) | 204.0 |
| ROS-037 (Example 8) | 174.0 |
| Mg-CUK-1 (Example 13) | 135.1 |
| hcp-UiO-66 (Example 16) | 123.6 |
| [Co₃(μ₃-OH)₂(btca)₂] (example 12) | 133.9 |
| sql-2-Cu-BF₄ (example 1) | 139.9 |
| Silica Gel | 27.8 |
| Mesoporous Silica | 2.5 |

Following the procedure of section 2.3, the working capacity was recorded after 40 minutes, as shown below in Table 4:

TABLE 4
Humidity Swing Testing

| | Working capacity |
|---|---|
| Metal-organic material | (cm³ water vapour/cm³ material) |
| Co-CUK-1 (Example 14) | 202.9 |
| ROS-037 (Example 8) | 185.3 |
| Mg-CUK-1 (Example 13) | 131.5 |
| hcp-UiO-66 (Example 16) | 102.4 |
| [Co₃(μ₃-OH)₂(btca)₂] (example 12) | 121.1 |
| sql-2-Cu-BF₄ (example 1) | 139.2 |
| Silica Gel | 21.0 |
| Mesoporous Silica | 3.6 |

### EXAMPLE 22: Thermodynamics of Desorption

As mentioned above, heat of desorption was calculated by combining measurements taken by thermogravimetric analysis, differential scanning calorimetry and intrinsic dynamic vapour sorption isotherm measurements. The results are shown in Table 5 below:

TABLE 5
Heat of Desorption

| Metal-organic material | Heat of desorption (kJ/mol) |
|---|---|
| ROS-037 | 43.3 |
| Mg-CUK-1 | 51.7 |
| Silica Gel | 59.4 |
| Syloid AL-1 | 76.1 |
| Zeolite 13X | 203.8 |

1. A method of capturing water from a gaseous composition comprising water vapour (suitably air), the method comprising:
(a) providing a metal-organic material; and
(b) contacting the metal-organic material with water and/or water vapour;
wherein upon contact with water and/or water vapour the material switches from a first state to a second state wherein the second state is able to retain a higher amount of water than the first state.

2. (canceled)

3. A metal-organic material wherein said material can exist in a first state and a second state; wherein switching from said first state to said second state occurs upon contact of the material with water and/or water vapour; and wherein said second state is able to retain a higher amount of water than said first state.

4. A device for capturing water from a gaseous composition comprising water vapour (suitably air), the device comprising a metal-organic material and a support; wherein the metal-organic material can exist in a first state and a second state; wherein switching from said first state to said second state occurs upon contact of the material with water and/or water vapour; and wherein said second state is able to retain a higher amount of water than said first state.

5. The method of claim 1, wherein the metal-organic material comprises metal species and ligands.

6. The method of claim 5 wherein the metal species is selected from copper, cobalt, nickel, iron, zinc, cadmium, zirconium, magnesium, calcium and aluminium.

7. The method of claim 1, wherein the ligands are selected from bidentate nitrogen ligands, nitrogen-carboxylate ligands and polycarboxylate ligands.

8. The method of claim 7 wherein the ligands are selected from 4,4′-bipyridine (L1), 1,4-bis(4-pyridyl)benzene (L2), 4,4′-(2,5-dimethyl-1,4-phenylene)dipyridine (L3), 1,4-bis(4-pyridyl)biphenyl (L4), 1,2-di(pyridine-4-yl)-ethene (L5), benzotriazole-5-carboxylic acid (L128), 2,4-pyridinedicarboxylic acid (L80), glutaric acid (L141) and benzene-1,4-dicarboxylic acid (L156).

9. The method of claim 1, wherein the metal-organic material further comprises one or more anions.

10. The method of claim 9 wherein the anions are selected from BF₄⁻, NO₃⁻, CF₃SO₃⁻ and glutarate.

11. The method of claim 1, wherein switching from a first state to a second state occurs when a threshold humidity is reached.

12. The method of claim 1, wherein the metal-organic material is a porous metal-organic framework material comprising pores which have a hydrophobic pore window and a hydrophilic internal pore surface.

13. The method of claim 12, wherein the porous metal-organic framework material is a microporous material.

14. The method of claim 12, wherein the porous metal-organic framework material is selected from [Cu₂(glutarate)₂(4,4′-bipyridine)], [Cu₂(glutarate)₂(1,2-di(pyridine-4-yl)-ethene)], [Co₃(μ₃-OH)₂(2,4-pyridinedicarboxylate)₂], [Mg₃(μ₃-OH)₂(2,4-pyridinedicarboxylate)₂], [Co₃(μ₃-OH)₂(benzotriazolate-5-carboxylate)₂] and [Zr₁₂O₈(μ₃-OH)₈(μ₂-OH)₆(benzene-1,4-dicarboxylate)₉].

15. The method of claim 14 wherein the porous metal-organic framework material is [Cu₂(glutarate)₂(4,4′-bipyridine)].

16. The method of claim 1, wherein the metal-organic material is a two-dimensional layered material.

17. The method of claim 16, wherein the two-dimensional layered material is selected from sql-3-Cu—BF₄, sql-2-Cu—BF₄, sql-2-Cu-OTf, sql-1-Cu—NO₃, sql-A14-Cu—NO₃, sql-1-Co-NO₃ and sql-1-Ni—NO₃.

18. The method of claim 1, wherein step (b) involves contacting the metal-organic material with ambient air of sufficient humidity to cause an increase in the amount of water the material is able to hold within its structure.

19-21. (canceled)

22. The method of claim 1, further comprising:
(c) transporting and/or storing the metal-organic material.

23. The method of claim 1, further comprising:
(d) applying a stimulus to the metal-organic material to effect desorption of water retained therein.

24. The method of claim 23, further comprising:
(e) collecting desorbed water.
